(19) United States
(12) Patent Application Publication
(10) Pub. No.: US 2024/0313837 A1
(43) Pub. Date: Sep. 19, 2024

(54) TECHNIQUES TO DETERMINE A PRIORITY OF A CHANNEL STATE INFORMATION REPORT

(71) Applicant: QUALCOMM Incorporated, San Diego, CA (US)

(72) Inventors: Tianyang BAI, Somerville, NJ (US); Yan ZHOU, San Diego, CA (US); Jelena DAMNJANOVIC, Del Mar, CA (US)

(21) Appl. No.: 18/185,938

(22) Filed: Mar. 17, 2023

(51) Int. Cl. H04B 7/06; H04W 72/566

(52) U.S. Cl. CPC H04B 7/0626; H04W 72/569

(57) ABSTRACT

Methods, systems, and devices for wireless communication are described. Some wireless communications systems may support a user equipment (UE) receiving, from a network entity, control information that schedules the UE to transmit a set of channel state information (CSI) reports during overlapping windows of time, based on measurements of respective sets of reference signals. The UE may transmit, to the network entity and during the overlapping windows of time, a prioritized CSI report from the set of CSI reports in accordance with a priority rule. The priority rule may define respective priorities for each CSI report of the set of CSI reports. The respective priorities may be based on the respective sets of reference signals being associated with a serving cell for the UE, one or more candidate serving cells for the UE, or both.

### FIELD OF TECHNOLOGY

The following relates to wireless communication, including techniques to determine a priority of a channel state information (CSI) report.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM).

A wireless multiple-access communications system may include one or more base stations, each supporting wireless communication for communication devices, which may be known as user equipment (UE). Some wireless communication systems may include uplink control information (UCI) messages to coordinate one or more processes between devices. A UCI may include a channel state information (CSI) report to indicate a quality of a communication channel.

### SUMMARY

The described techniques relate to improved methods, systems, devices, and apparatuses that support techniques to determine a priority of a channel state information (CSI) report. For example, the described techniques enable a user equipment (UE), a network entity, or both to prioritize one or more CSI reports according to a priority rule as described herein. The UE may receive control information from the network entity which may schedule the UE to transmit a set of CSI reports. The UE may perform measurements of one or more sets of reference signals (e.g., sets of reference signals indicated in the control information) to generate the set of CSI reports. In some examples, two or more of the set of CSI reports may be scheduled during overlapping windows of time. The UE may transmit a prioritized CSI report from the set of CSI reports according to the priority rule. The priority rule may define a respective priority for each CSI report of the set of CSI reports, and respective priorities may be based on the CSI report being associated with a serving cell for the UE, one or more candidate serving cells for the UE, or both.

A method for wireless communications at a UE is described. The method may include receiving, from a network entity, control information that schedules the UE to transmit a set of multiple CSI reports during overlapping windows of time, the set of multiple CSI reports each based on measurements of respective sets of reference signals and transmitting, to the network entity and during the overlapping windows of time, a prioritized CSI report from the set of multiple CSI reports in accordance with a priority rule, where the priority rule defines a priority of each of the set of multiple CSI reports, where respective priorities corresponding to the set of multiple CSI reports are based on the respective sets of reference signals being associated with a serving cell for the UE, one or more candidate serving cells for the UE, or both the serving cell for the UE and the one or more candidate serving cells for the UE.

An apparatus for wireless communications at a UE is described. The apparatus may include a processor, memory coupled with the processor, and instructions stored in the memory. The instructions may be executable by the processor to cause the apparatus to receive, from a network entity, control information that schedules the UE to transmit a set of multiple CSI reports during overlapping windows of time, the set of multiple CSI reports each based on measurements of respective sets of reference signals and transmit, to the network entity and during the overlapping windows of time, a prioritized CSI report from the set of multiple CSI reports in accordance with a priority rule, where the priority rule defines a priority of each of the set of multiple CSI reports, where respective priorities corresponding to the set of multiple CSI reports are based on the respective sets of reference signals being associated with a serving cell for the UE, one or more candidate serving cells for the UE, or both the serving cell for the UE and the one or more candidate serving cells for the UE.

Another apparatus for wireless communications at a UE is described. The apparatus may include means for receiving, from a network entity, control information that schedules the UE to transmit a set of multiple CSI reports during overlapping windows of time, the set of multiple CSI reports each based on measurements of respective sets of reference signals and means for transmitting, to the network entity and during the overlapping windows of time, a prioritized CSI report from the set of multiple CSI reports in accordance with a priority rule, where the priority rule defines a priority of each of the set of multiple CSI reports, where respective priorities corresponding to the set of multiple CSI reports are based on the respective sets of reference signals being associated with a serving cell for the UE, one or more candidate serving cells for the UE, or both the serving cell for the UE and the one or more candidate serving cells for the UE.

A non-transitory computer-readable medium storing code for wireless communications at a UE is described. The code may include instructions executable by a processor to receive, from a network entity, control information that schedules the UE to transmit a set of multiple CSI reports during overlapping windows of time, the set of multiple CSI reports each based on measurements of respective sets of reference signals and transmit, to the network entity and during the overlapping windows of time, a prioritized CSI report from the set of multiple CSI reports in accordance with a priority rule, where the priority rule defines a priority of each of the set of multiple CSI reports, where respective priorities corresponding to the set of multiple CSI reports are based on the respective sets of reference signals being associated with a serving cell for the UE, one or more candidate serving cells for the UE, or both the serving cell for the UE and the one or more candidate serving cells for the UE.

Some examples of the method, apparatuses, and non-transitory computer-readable medium described herein may further include operations, features, means, or instructions for determining the respective priorities for each of the set of multiple CSI reports based on the priority rule, where the prioritized CSI report may have a highest respective priority of the respective priorities.

Some examples of the method, apparatuses, and non-transitory computer-readable medium described herein may further include operations, features, means, or instructions for weighting an input to the priority rule based on whether the respective set of reference signals for a corresponding one of the set of multiple CSI reports may be associated with the serving cell for the UE, the one or more candidate serving cells for the UE, or both the serving cell for the UE and the one or more candidate serving cells for the UE.

In some examples of the method, apparatuses, and non-transitory computer-readable medium described herein, the input may be assigned a greater weight when the respective set of reference signals may be associated with the serving cell for the UE than when the respective set of reference signals may be associated with only the one or more candidate serving cells for the UE.

In some examples of the method, apparatuses, and non-transitory computer-readable medium described herein, the priority rule includes, as an input, a cell identifier associated with a respective one of the set of multiple CSI reports and the cell identifier may be of the serving cell when the respective sets of reference signals may be associated with the serving cell for the UE or associated with both the serving cell for the UE and the one or more candidate serving cells for the UE.

In some examples of the method, apparatuses, and non-transitory computer-readable medium described herein, the priority rule includes, as an input, a cell identifier associated with a respective one of the set of multiple CSI reports and the cell identifier may be of a one of the one or more candidate serving cells when the respective sets of reference signals may be associated with only the one or more candidate serving cells for the UE.

In some examples of the method, apparatuses, and non-transitory computer-readable medium described herein, the one of the one or more candidate serving cells may have either a smallest cell identifier of the one or more candidate serving cells or a largest cell identifier of the one or more candidate serving cells.

Some examples of the method, apparatuses, and non-transitory computer-readable medium described herein may further include operations, features, means, or instructions for determining the prioritized CSI report based on the priority rule, where the priority rule assigns a greater weight to an input when the respective set of reference signals may be associated with an active serving cell for the UE than when the respective set of reference signals may be associated with a deactivated serving cell for the UE.

In some examples of the method, apparatuses, and non-transitory computer-readable medium described herein, the priority rule assigns a greater weight to the input when the respective set of reference signals may be associated with the deactivated serving cell for the UE than when the respective set of reference signals may be associated with only a candidate serving cell for the UE.

Some examples of the method, apparatuses, and non-transitory computer-readable medium described herein may further include operations, features, means, or instructions for determining the prioritized CSI report based on the priority rule, where the priority rule assigns a greater weight to an input when the respective set of reference signals may be associated with an intra-frequency measurement type than when the respective set of reference signals may be associated with an inter-frequency measurement type.

Some examples of the method, apparatuses, and non-transitory computer-readable medium described herein may further include operations, features, means, or instructions for determining the prioritized CSI report based on the priority rule, where the priority rule assigns a first weight to an input when the respective set of reference signals may be associated with an aperiodic report type, a second weight to the input when the respective set of reference signals may be associated with an event-triggered report type, a third weight to the input when the respective set of reference signals may be associated with a semi-persistent report type, or a fourth weight to the input when the respective set of reference signals may be associated with a periodic report type, where the first weight may be greater than the second weight, which may be greater than the third weight, which may be greater than the fourth weight.

Some examples of the method, apparatuses, and non-transitory computer-readable medium described herein may further include operations, features, means, or instructions for determining a first CSI report corresponding to a first set of reference signals, where the first set of reference signals may be associated with the serving cell for the UE and determining a second CSI report corresponding to a second set of reference signals, where the second set of reference signals may be associated with a candidate serving cell for the UE, and where transmitting the prioritized CSI report includes transmitting the first CSI report in accordance with the priority rule prioritizing the serving cell for the UE over the candidate serving cell for the UE.

In some examples of the method, apparatuses, and non-transitory computer-readable medium described herein, parameters of the priority rule include at least one of a type of measurement report, an indication of whether a reference signal received power value or a signal to noise ratio value may be included in a corresponding one of the set of multiple CSI reports, a serving cell index, a maximum number of serving cells, a report identifier for a CSI report, a maximum number of CSI report indications, an input distinguishing CSI reports carrying serving cell measurement and candidate cell measurement, a term having a first value indicating that the set of multiple CSI reports may be not associated with any reference signal in the serving cell and the term may have a second value indicating that the set of multiple CSI reports may be associated with a reference signal in the serving cell, or a combination thereof.

Some examples of the method, apparatuses, and non-transitory computer-readable medium described herein may further include operations, features, means, or instructions for transmitting, to the network entity, an indication indicating whether the prioritized CSI report may be triggered based on a mobility event at the UE.

In some examples of the method, apparatuses, and non-transitory computer-readable medium described herein, the indication may be transmitted using at least one of an explicit bit in the prioritized CSI report, a field in the prioritized CSI report, one or more scrambling sequences of a demodulation reference signal, or a combination thereof.

A method for wireless communications at a network entity is described. The method may include transmitting, to a UE, control information that schedules the UE to transmit a set of multiple CSI reports during overlapping windows of time, the set of multiple CSI reports each based on measurements of respective sets of reference signals and receiving, from the UE and during the overlapping windows of time, a prioritized CSI report from the set of multiple CSI reports in accordance with a priority rule, where the priority rule defines a priority of each of the set of multiple CSI reports, where respective priorities corresponding to the set of multiple CSI reports are based on the respective sets of reference signals being associated with a serving cell for the UE, one or more candidate serving cells for the UE, or both the serving cell for the UE and the one or more candidate serving cells for the UE.

An apparatus for wireless communications at a network entity is described. The apparatus may include a processor, memory coupled with the processor, and instructions stored in the memory. The instructions may be executable by the processor to cause the apparatus to transmit, to a UE, control information that schedules the UE to transmit a set of multiple CSI reports during overlapping windows of time, the set of multiple CSI reports each based on measurements of respective sets of reference signals and receive, from the UE and during the overlapping windows of time, a prioritized CSI report from the set of multiple CSI reports in accordance with a priority rule, where the priority rule defines a priority of each of the set of multiple CSI reports, where respective priorities corresponding to the set of multiple CSI reports are based on the respective sets of reference signals being associated with a serving cell for the UE, one or more candidate serving cells for the UE, or both the serving cell for the UE and the one or more candidate serving cells for the UE.

Another apparatus for wireless communications at a network entity is described. The apparatus may include means for transmitting, to a UE, control information that schedules the UE to transmit a set of multiple CSI reports during overlapping windows of time, the set of multiple CSI reports each based on measurements of respective sets of reference signals and means for receiving, from the UE and during the overlapping windows of time, a prioritized CSI report from the set of multiple CSI reports in accordance with a priority rule, where the priority rule defines a priority of each of the set of multiple CSI reports, where respective priorities corresponding to the set of multiple CSI reports are based on the respective sets of reference signals being associated with a serving cell for the UE, one or more candidate serving cells for the UE, or both the serving cell for the UE and the one or more candidate serving cells for the UE.

A non-transitory computer-readable medium storing code for wireless communications at a network entity is described. The code may include instructions executable by a processor to transmit, to a UE, control information that schedules the UE to transmit a set of multiple CSI reports during overlapping windows of time, the set of multiple CSI reports each based on measurements of respective sets of reference signals and receive, from the UE and during the overlapping windows of time, a prioritized CSI report from the set of multiple CSI reports in accordance with a priority rule, where the priority rule defines a priority of each of the set of multiple CSI reports, where respective priorities corresponding to the set of multiple CSI reports are based on the respective sets of reference signals being associated with a serving cell for the UE, one or more candidate serving cells for the UE, or both the serving cell for the UE and the one or more candidate serving cells for the UE.

In some examples of the method, apparatuses, and non-transitory computer-readable medium described herein, the priority rule indicates that the prioritized CSI report may have a highest respective priority of the respective priorities.

In some examples of the method, apparatuses, and non-transitory computer-readable medium described herein, the priority rule indicates that an input to the priority rule may be weighed based on whether the respective set of reference signals for a corresponding one of the set of multiple CSI reports may be associated with the serving cell for the UE, the one or more candidate serving cells for the UE, or both the serving cell for the UE and the one or more candidate serving cells for the UE.

In some examples of the method, apparatuses, and non-transitory computer-readable medium described herein, the input may be assigned a greater weight when the respective set of reference signals may be associated with the serving cell for the UE than when the respective set of reference signals may be associated with only the one or more candidate serving cells for the UE.

In some examples of the method, apparatuses, and non-transitory computer-readable medium described herein, the priority rule includes, as an input, a cell identifier associated with a respective one of the set of multiple CSI reports and the cell identifier may be of the serving cell when the respective sets of reference signals may be associated with the serving cell for the UE or associated with both the serving cell for the UE and the one or more candidate serving cells for the UE.

In some examples of the method, apparatuses, and non-transitory computer-readable medium described herein, the priority rule includes, as an input, a cell identifier associated with a respective one of the set of multiple CSI reports and the cell identifier may be of a one of the one or more candidate serving cells when the respective sets of reference signals may be associated with only the one or more candidate serving cells for the UE.

In some examples of the method, apparatuses, and non-transitory computer-readable medium described herein, the one of the one or more candidate serving cells may have either a smallest cell identifier of the one or more candidate serving cells or a largest cell identifier of the one or more candidate serving cells.

In some examples of the method, apparatuses, and non-transitory computer-readable medium described herein, the priority rule assigns a greater weight to an input when the respective set of reference signals may be associated with an active serving cell for the UE than when the respective set of reference signals may be associated with a deactivated serving cell for the UE.

In some examples of the method, apparatuses, and non-transitory computer-readable medium described herein, the priority rule assigns a greater weight to the input when the respective set of reference signals may be associated with the deactivated serving cell for the UE than when the respective set of reference signals may be associated with only a candidate serving cell for the UE.

In some examples of the method, apparatuses, and non-transitory computer-readable medium described herein, the priority rule assigns a greater weight to an input when the respective set of reference signals may be associated with an intra-frequency measurement type than when the respective set of reference signals may be associated with an inter-frequency measurement type.

In some examples of the method, apparatuses, and non-transitory computer-readable medium described herein, the priority rule assigns a first weight to an input when the respective set of reference signals may be associated with an aperiodic report type, a second weight to the input when the respective set of reference signals may be associated with an event-triggered report type, a third weight to the input when the respective set of reference signals may be associated with a semi-persistent report type, or a fourth weight to the input when the respective set of reference signals may be associated with a periodic report type and the first weight may be greater than the second weight, which may be greater than the third weight, which may be greater than the fourth weight.

In some examples of the method, apparatuses, and non-transitory computer-readable medium described herein, parameters of the priority rule include at least one of a type of measurement report, an indication of whether a reference signal received power value or a signal to noise ratio value may be included in a corresponding one of the set of multiple CSI reports, a serving cell index, a maximum number of serving cells, a report identifier for a CSI report, a maximum number of CSI report indications, an input distinguishing CSI reports carrying serving cell measurement and candidate cell measurement, a term having a first value indicating that the set of multiple CSI reports may be not associated with any reference signal in the serving cell and the term may have a second value indicating that the set of multiple CSI reports may be associated with a reference signal in the serving cell, or a combination thereof.

Some examples of the method, apparatuses, and non-transitory computer-readable medium described herein may further include operations, features, means, or instructions for receiving, from the UE, an indication indicating whether the prioritized CSI report may be triggered based on a mobility event at the UE.

In some examples of the method, apparatuses, and non-transitory computer-readable medium described herein, the indication may be received using at least one of an explicit bit in the prioritized CSI report, a field in the prioritized CSI report, one or more scrambling sequences of a demodulation reference signal, or a combination thereof.

### BRIEF DESCRIPTION OF THE DRAWINGS

FIGS. 1 and 2 show examples of wireless communications systems that support techniques to determine a priority of a channel state information (CSI) report in accordance with one or more aspects of the present disclosure.

FIG. 3 shows an example of a process flow that supports techniques to determine a priority of a CSI report in accordance with one or more aspects of the present disclosure.

FIGS. 4 and 5 show block diagrams of devices that support techniques to determine a priority of a CSI report in accordance with one or more aspects of the present disclosure.

FIG. 6 shows a block diagram of a communications manager that supports techniques to determine a priority of a CSI report in accordance with one or more aspects of the present disclosure.

FIG. 7 shows a diagram of a system including a device that supports techniques to determine a priority of a CSI report in accordance with one or more aspects of the present disclosure.

FIGS. 8 and 9 show block diagrams of devices that support techniques to determine a priority of a CSI report in accordance with one or more aspects of the present disclosure.

FIG. 10 shows a block diagram of a communications manager that supports techniques to determine a priority of a CSI report in accordance with one or more aspects of the present disclosure.

FIG. 11 shows a diagram of a system including a device that supports techniques to determine a priority of a CSI report in accordance with one or more aspects of the present disclosure.

FIGS. 12 through 15 show flowcharts illustrating methods that support techniques to determine a priority of a CSI report in accordance with one or more aspects of the present disclosure.

### DETAILED DESCRIPTION

In a wireless communication system, a user equipment (UE) may transmit one or more uplink control information (UCI) messages to a network entity. In some cases, the UCI messages may include channel state information (CSI) reports to indicate a quality of a communication channel. The network entity may schedule multiple CSI reports for transmission during overlapping windows of time (e.g., the scheduled CSI report transmission times may overlap). However, in some examples, the UE and the network entity may be constrained to transmitting or receiving a single CSI report at a time (or during a particular time window). Accordingly, the UE may determine a priority associated with each CSI report of the multiple CSI reports to determine which of the CSI report to transmit (e.g., to transmit first).

Some priority determination methods may consider multiple factors to determine the priority of each CSI report such as a report type (e.g., aperiodic report, semi-persistent report, periodic report), an associated serving cell identifier, and a report configuration identifier. However, such a priority determination technique may not account for conditions related to some cell switching procedures (e.g., layer 1/layer 2 triggered mobility (LTM) procedures), among other conditions. For example, such a priority determination technique may not account for CSI reports that are associated with cells other than the serving cell for the UE (e.g., candidate serving cells, deactivated serving cells), or event triggered CSI report types, or other conditions. Thus, the wireless communication system may improperly determine respective priorities for CSI reports in cases where such additional conditions are present, which may lead to increased latency and reduced efficiency in communication.

In accordance with aspects described herein, the UE (e.g., or the network entity, or both), may utilize a priority rule which accounts for CSI reports associated with candidate serving cells, event triggered CSI reports, and other conditions. In some examples, the UE may include additional parameters or modify parameters in a priority metric computation to account for such conditions. For example, the priority rule may increase a priority for CSI reports associated with any reference signals in a serving cell and decrease the priority for the CSI report associated with reference signals in a candidate serving cell. The priority rule may further prioritize CSI reports (e.g., CSI reports associated with a same cell type, or a same report type) based on an order of cell identifiers associated with the CSI reports. The priority rule may include considerations for event triggered CSI reports (e.g., LTM report based on a layer 1 (L1) measurement). For example, the priority rule may prioritize aperiodic reports over event triggered reports, event triggered reports over semi-persistent reports, and semi-persistent reports over periodic reports.

Aspects of the disclosure are initially described in the context of wireless communications systems, and a process flow. Aspects of the disclosure are further illustrated by and described with reference to apparatus diagrams, system diagrams, and flowcharts that relate to techniques to determine priority of CSI reports.

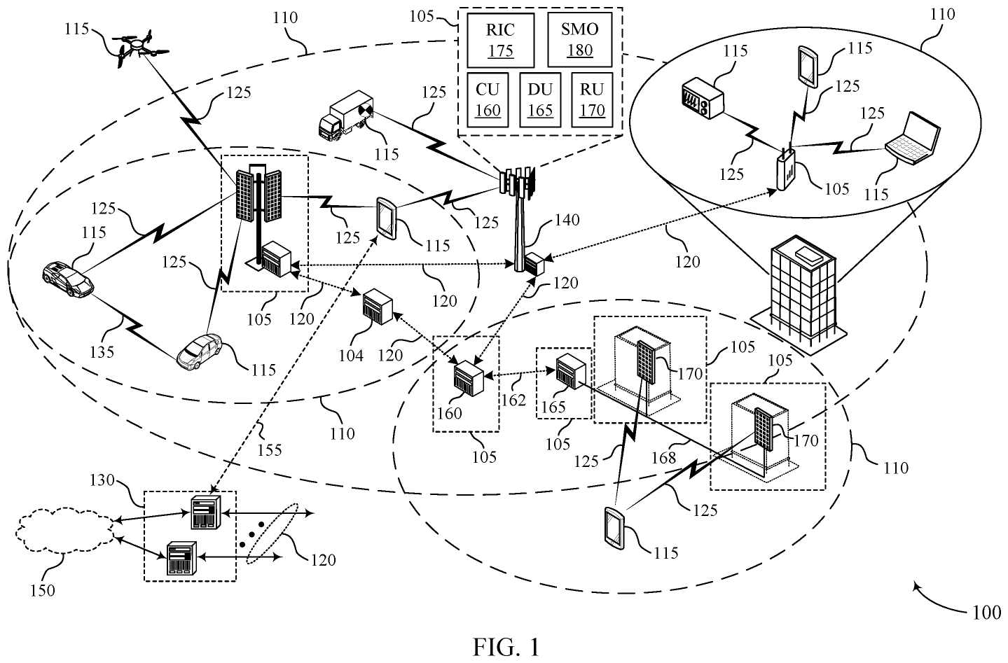

FIG. 1 shows an example of a wireless communications system 100 that supports techniques to determine a priority of a CSI report in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c. F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

For instance, an access network (AN) or RAN may include communications between access nodes (e.g., an IAB donor), IAB nodes 104, and one or more UEs 115. The IAB donor may facilitate connection between the core network 130 and the AN (e.g., via a wired or wireless connection to the core network 130). That is, an IAB donor may refer to a RAN node with a wired or wireless connection to core network 130. The IAB donor may include a CU 160 and at least one DU 165 (e.g., and RU 170), in which case the CU 160 may communicate with the core network 130 via an interface (e.g., a backhaul link). IAB donor and IAB nodes 104 may communicate via an F1 interface according to a protocol that defines signaling messages (e.g., an F1 AP protocol). Additionally, or alternatively, the CU 160 may communicate with the core network via an interface, which may be an example of a portion of backhaul link, and may communicate with other CUs 160 (e.g., a CU 160 associated with an alternative IAB donor) via an Xn-C interface, which may be an example of a portion of a backhaul link.

An IAB node 104 may refer to a RAN node that provides IAB functionality (e.g., access for UEs 115, wireless self-backhauling capabilities). A DU 165 may act as a distributed scheduling node towards child nodes associated with the IAB node 104, and the IAB-MT may act as a scheduled node towards parent nodes associated with the IAB node 104. That is, an IAB donor may be referred to as a parent node in communication with one or more child nodes (e.g., an IAB donor may relay transmissions for UEs through one or more other IAB nodes 104). Additionally, or alternatively, an IAB node 104 may also be referred to as a parent node or a child node to other IAB nodes 104, depending on the relay chain or configuration of the AN. Therefore, the IAB-MT entity of IAB nodes 104 may provide a Uu interface for a child IAB node 104 to receive signaling from a parent IAB node 104, and the DU interface (e.g., DUs 165) may provide a Uu interface for a parent IAB node 104 to signal to a child IAB node 104 or UE 115.

For example, IAB node 104 may be referred to as a parent node that supports communications for a child IAB node, or referred to as a child IAB node associated with an IAB donor, or both. The IAB donor may include a CU 160 with a wired or wireless connection (e.g., a backhaul communication link 120) to the core network 130 and may act as parent node to IAB nodes 104. For example, the DU 165 of IAB donor may relay transmissions to UEs 115 through IAB nodes 104, or may directly signal transmissions to a UE 115, or both. The CU 160 of IAB donor may signal communication link establishment via an F1 interface to IAB nodes 104, and the IAB nodes 104 may schedule transmissions (e.g., transmissions to the UEs 115 relayed from the IAB donor) through the DUs 165. That is, data may be relayed to and from IAB nodes 104 via signaling via an NR Uu interface to MT of the IAB node 104. Communications with IAB node 104 may be scheduled by a DU 165 of IAB donor and communications with IAB node 104 may be scheduled by DU 165 of IAB node 104.

In the case of the techniques described herein applied in the context of a disaggregated RAN architecture, one or more components of the disaggregated RAN architecture may be configured to support techniques to determine a priority of a CSI report as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID), or others). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered network entity 105 (e.g., a lower-powered base station 140), as compared with a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or multiple cells and may also support communications via the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may support synchronous or asynchronous operation. For synchronous operation, network entities 105 (e.g., base stations 140) may have similar frame timings, and transmissions from different network entities 105 may be approximately aligned in time. For asynchronous operation, network entities 105 may have different frame timings, and transmissions from different network entities 105 may, in some examples, not be aligned in time. The techniques described herein may be used for either synchronous or asynchronous operations.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may also operate using a super high frequency (SHF) region, which may be in the range of 3 GHz to 30 GHZ, also known as the centimeter band, or using an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the network entities 105 (e.g., base stations 140, RUs 170), and EHF antennas of the respective devices may be smaller and more closely spaced than UHF antennas. In some examples, such techniques may facilitate using antenna arrays within a device. The propagation of EHF transmissions, however, may be subject to even greater attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by transmitting device (e.g., a transmitting network entity 105, a transmitting UE 115) along a single beam direction (e.g., a direction associated with the receiving device, such as a receiving network entity 105 or a receiving UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a receiving device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., a communication link 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

In some examples of the wireless communications system 100, a UE 115 may be camped on a serving cell which may include a primary cell and one or more secondary cells. In some cases, a communication quality between the serving cell and the UE 115 may degrade (e.g., due to the UE moving outside the coverage area) such that the UE 115 may trigger a process to switch to a different primary cell within the serving cell or to a different serving cell to improve communication quality. In such cases, a network entity 105 may configure the UE 115 to measure signals (e.g., reference signals) associated with one or more candidate serving cells associated with the serving cell (e.g., secondary cells) to identify a cell for cell switching. Additionally, or alternatively, as part of layer 1/layer 2 triggered mobility (LTM) procedures, the UE 115 may independently determine to measure signals associated with one or more candidate serving cells for cell switching. A candidate serving cell may refer to any cell considered for cell switching that is not associated with or otherwise included in the serving cell. Cell switching may also be referred to as an inter-cell mobility procedure, a handover procedure, or the like.

In cases where reference signals from candidate serving cells are included, the wireless communication system 100 may utilize LTM procedures to perform at least some aspects of cell switching. In such cases, a control message associated with a protocol layer (e.g., DCI, MAC control element (MAC-CE)) may trigger the cell switching procedure. In some examples, certain mechanisms and procedures (e.g., specified by an industry standard) may reduce latency in LTM procedures such as multiple candidate serving cell configuration, candidate serving cell maintenance procedures, dynamic switching mechanisms (e.g., among candidate serving cells), inter-cell beam management procedures (e.g., L1 measurement and reporting, beam indication), timing advance management, centralized unit (CU) distributed unit (DU) interface signaling, and the like.

The wireless communications system 100 may support various methods for cell selection in inter-cell mobility procedures (e.g., LTM procedures). For instance, the cell selection may be associated with a first method (e.g., Class 1), a second method (e.g., Class 2), or both. The first method may apply to individual cell selection, where separate signaling is used for primary cell change and secondary cell change (e.g., in cases of carrier aggregation (CA)). The primary cell selection may be based on beam indication from one or more candidate serving cells and secondary cell selection may be based on current techniques or L1/L2 signaling (e.g., DCI or MAC-CE based). In some cases, the UE 115 may select a single primary cell (e.g., cell without CA or dual-connectivity (DC)) from a set of pre-configured candidate primary cells. Additionally, or alternatively, the UE 115 may select the primary cell according to a primary cell-secondary cell swap among a set of pre-configured candidate primary cells (e.g., in cases of change in CA). The second method may apply to a group-based cell selection, where a special cell (e.g., SpCell) and a secondary cell may be switched together (e.g., in case of CA). The cell group switch signaling may be based on an extension of signaling for the first method (e.g., Class 1), or some other method.

In some examples, the UE 115 may be configured with multiple component carriers (CCs) or BWPs and with a pool of transmission configuration indicator (TCI) states or uplink (UL) TCI states in a respective CC or BWP. The UE 115 may further receive a reference cell identifier for applying the TCI state pool configuration. In some examples, the reference cell identifier may be configured in an RRC field. In some examples, the UE 115 may further be configured with path loss (PL) reference signal (RS) and power control (PC) parameters (e.g., pathlossReferenceRS-Id, ul-powerControl), which may refer to different list elements based on whether an RRC field is configured or not configured.

To support cell switching, the network entity 105 associated with the serving cell may configure the UE 115 to transmit one or more uplink control information (UCI) messages, which may be associated with a message type such as ACK/NACK (A/N), scheduling request (SR), CSI, or some other type. For example, the network entity 105 may configure the UE 115 to measure reference signals associated with the serving cell, reference signals associated with one or more candidate serving cells, or both, and transmit a CSI report to the network entity 105 via the UCI identifying a cell for cell switching. Additionally, or alternatively, the UE 115 may independently perform measurements (e.g., L1 measurements) of reference signals and generate a CSI report for transmission. The network entity 105 may configure the UE 115 to transmit the CSI report according to a periodic schedule, a semi-persistent schedule, an aperiodic schedule, or some combination thereof. Additionally, or alternatively, the wireless communications system 100 may support an event triggered CSI reports (e.g., in LTM procedures such as an LTM report or an event triggered L1 report) in addition to network-scheduled CSI reports. In some cases, the wireless communications system 100 may support event triggered report for L1 report of candidate serving cells and for intra-cell beam management report, among other examples.

In some cases, multiple CSI reports may be scheduled for transmission during a same or a partially overlapping time window. In some examples, the UE 115, the network entity 105, or both, may support transmission of a single UCI (e.g., a single CSI report) during a given time window. Thus, the UE 115 may determine a priority for each of the multiple UCIs (e.g., CSI reports) according to a priority rule to determine which UCI (or which CSI report) to transmit first. For example, a UCI priority rule may be defined for serving cell CSI reports when two or more CSI reports overlap in time. However, existing priority rules for UCI may not account for CSI reports associated with candidate serving cells (e.g., non-serving cells) or event triggered CSI reports, which may negatively impact communication quality. For example, some wireless communications systems may improperly handle situations when a candidate serving cell CSI report overlaps with a serving cell CSI report, when an event triggered CSI report (e.g., L1 report, LTM report) overlaps with an aperiodic, semi-persistent, or periodic report, and when multiple candidate serving cell CSI reports overlap, among other examples.

To improve cell switching procedures and improve prioritization of UCI (e.g., support LTM procedures, support additional CSI report types for a candidate serving cell), the wireless communications system 100 may support a UCI priority rule that is further based on CSI reports associated with candidate serving cells, event triggered CSI reports (e.g., for candidate serving cells and serving cells), LTM conditions, and other parameters. In some examples, the UE 115, the network entity 105, or some other device in the wireless communications system 100 may compute a priority metric for a CSI report based on the one or more conditions, as described herein. Thus, the wireless communications system 100 may improve communication quality using a more robust UCI prioritization procedure.

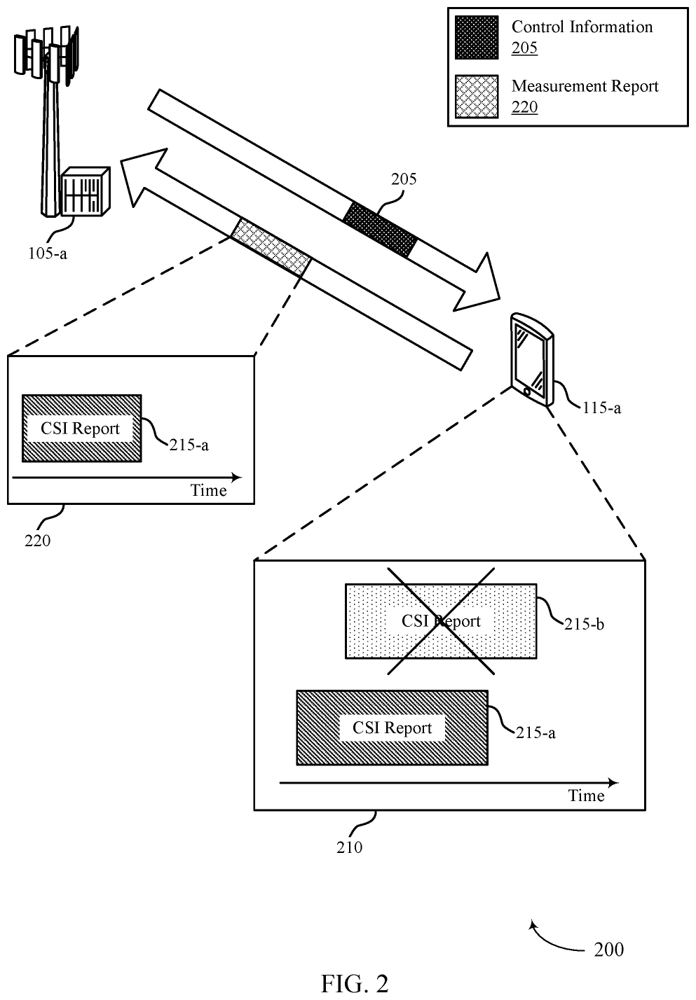

FIG. 2 shows an example of a wireless communications system 200 that supports techniques to determine a priority of a CSI report in accordance with one or more aspects of the present disclosure. The wireless communications system 200 may implement or be implemented by aspects of the wireless communications system 100 as described with reference to FIG. 1. For example, the wireless communications system 200 may include a network entity 105-a and a UE 115-a, which may represent examples of a network entity 105 and a UE 115 as described with reference to FIG. 1. The network entity 105-a may be associated with a serving cell for the UE 115-a (e.g., serving cell where UE 115-a is camped). The UE 115-a may transmit one or more UCI messages, which may be CSI reports 215. According to techniques described herein, the UE 115-a may prioritize the transmission of the one or more CSI reports 215.

The UE 115-a may receive a control information message 205 which may configure the UE to transmit one or more UCI messages. In some cases, the control information message 205 may include information such as a report configuration (e.g., for a CSI report 215), a report configuration identifier, a serving cell identifier, some other information, or any combination thereof. The report configuration may indicate a type of UCI message for the UE to transmit such as an A/N, SR, or CSI report. In the case of a CSI report 215 included in a UCI, the control information message 205 may further indicate a type of CSI report 215 such as aperiodic, semi-persistent, periodic, or some other type.

In some cases, the network entity 105-a may configure the UE 115-a with multiple CCs or BWPs. The UE 115-a may further be configured with a pool of TCI states or UL TCI states in a CC or BWP. In some examples, if the UE 115-a is not configured with a pool of TCI states or UL TCI states in a CC or BWP, the UE 115-a may receive a reference cell identifier (ID) (e.g., in control information 205). In some cases, the UE 115-a may apply a TCI state pool configuration associated with the reference cell to the CC or BWP. In some examples, the reference cell ID may be configured in an RRC field, cell, associated with a TCI state information element (IE), or an RRC field, servingCellId, associated with an UL TCI state IE, or both.

In some examples, UE 115-a may be configured with a path loss (PL) reference signal (RS) and power control (PC) parameters for a TCI state or UL TCI state. For example, the UE 115-a may be configured with an RRC parameter, pathlossReferenceRS-Id, which may be an index referring to a list element in a list of PL RSs configured in the UL BWP and a serving cell where the associated TCI state or UL TCI state is applied. In some cases, the UE 115-a may be configured with the RRC parameter (e.g., pathlossReferenceRS-Id) regardless of whether the RRC field, cell, is configured or not configured for the TCI state, or whether the RRC field, servingCellId, is configured or not configured for the UL TCI state.

Additionally, or alternatively, in some examples, when the field, cell, is configured for a TCI state, or the field, servingCellId, is configured for a UL TCI state, the UE 115-a may be configured with a pathlossReferenceRS-Id, which may be an index referring to a list element in a list configured in an UL BWP of the serving cell indicated by cell or servingCellId. In some examples, when the field, cell, or servingCellId, is not configured (e.g., is absent), the pathlossReferenceRS-Id may refer to a list element in a list configured in the UL BWP and the serving cell where the TCI state or the UL TCI state is applied to. Additionally, or alternatively, when the field, cell, or servingCellId, is configured (e.g., is present), the UE 115-a may be further configured with an additional field to indicate which UL BWP or CC in the list of PL RSs is referred to by the RRC parameter, pathlossReferenceRS-Id. If the additional field is not configured for the UE 115-a (e.g., is not present), the UE 115-a may assume that the RRC parameter, pathlossReferenceRS-Id, refers to a list element in a list configured in the UL BWP and the serving cell where the TCI state or UL TCI state is applied.

Similarly, in some examples, UE 115-a may be configured with an RRC parameter, ul-powerControl, which may be an index referring to a list element in a list of PC parameter settings configured in the serving cell where the TCI state is configured, regardless of if the RRC field, cell, or servingCellId, is configured for the associated TCI state or UL TCI state. Additionally, or alternatively, the RRC parameter ul-powerControl may refer to a list element in a list of PC parameter settings configured in the serving cell where the TCI state is applied to, regardless of if the RRC field, cell, or servingCellId, is configured for the associated TCI state or UL TCI state.

The communication quality between a current serving cell and the UE 115-a may degrade under some conditions. For example, the UE 115-a may move out of range of the serving cell or some other condition may degrade the communication quality. In some cases, to improve the communication quality, the UE 115-a may switch from a current primary cell to a different primary cell (e.g., within the current serving cell). In some other cases, the UE 115-a may switch from the current serving cell to a different serving cell. To enable cell switching, the network entity 105-a may configure the UE 115-a to perform measurements (e.g., CSI measurements) of reference signals associated with the serving cell (e.g., primary cell reference signals, secondary cell reference signals) and transmit a measurement report 220 which may include a CSI report 215. In some cases, the wireless communications system 200 may employ LTM procedures to perform cell switching.

In some cases, the wireless communications system 200 may schedule multiple UCI messages (e.g., including CSI reports 215) for transmission during a same or a partially overlapping time window. However, the UE 115-a may be constrained to transmitting a single UCI (e.g., a single CSI report) at a time. Thus, the network entity 105-a, the UE 115-a, or both may determine a priority for each of the multiple UCIs (e.g., including CSI reports) according to a priority rule to determine which UCI to transmit (e.g., or transmit first). For example, the UE 115-a may generate a CSI report 215-a and a CSI report 215-b which may overlap in a time window 210. The UE 115-a may determine that a priority for the CSI report 215-a is higher than a priority for the CSI report 215-b according to the priority rule. Thus, the UE 115-a may determine to transmit CSI report 215-a in the measurement report 220 (e.g., UCI report) to the network entity 105-a. The UE 115-a may not transmit the lower priority CSI report 215-b (e.g., may drop the transmission) or may delay the transmission of the lower priority CSI report 215-b until after the transmission of the CSI report 215-a.

In some examples, a priority rule may prioritize a UCI based on the UCI type (e.g., A/N, SR, or CSI), such that when UCIs of different types overlap, the priority rule may prioritize A/N UCI over SR UCI, and prioritize SR UCI over CSI report UCI (e.g., A/N>SR>CSI report). The priority rule may additionally combine a set of parameters in accordance with a mathematical equation to determine a priority metric (e.g., priority score) for each CSI report. In some cases, when two or more CSI reports 215 overlap in time (e.g., CSI report 215-a and CSI report 215-b) the UE 115-a, the network entity 105-a, or both may compute the priority metric for each CSI report 215 according to the priority rule. A lower priority metric value may correspond to a higher priority CSI report. For example, the UE 115-a may compute a relatively lower priority metric for CSI report 215-a than a priority metric for CSI report 215-b. Thus, UE 115-a may determine that CSI report 215-a has higher priority than CSI report 215-b. Specifically, the priority metric for the current priority rule may be determined according to Equation 1.

$${Pri}_{iCSI} ( y , k , c , s ) = 2 \cdot {N}_{cells} \cdot {M}_{s} \cdot y + {N}_{cells} \cdot {M}_{s} \cdot k + {M}_{s} \cdot c + s \qquad ( 1 )$$

In the example of Equation 1, N_{cells} may represent a maximum quantity of cells that the network may configure at the UE 115-a, and Mₛ may represent a maximum quantity of different report configuration types that the network may configure within a given cell (e.g., a current serving cell). The parameter y may be associated with a type of CSI report. Specifically, values for y may be defined as follows: y=0 for aperiodic reports, y=1 for semi-persistent reports on physical uplink shared channel (PUSCH), y=2 for semi-persistent reports on physical uplink control channel (PUCCH), and y=3 for periodic reports on PUCCH. The parameter k may be associated with whether reference signal received power (RSRP) or signal to interference plus noise ratio (SINR) is included in the CSI report 215. Specifically values for k may be defined as follows: k=0 if L1 RSRP/SINR is included and k=1 if L1 RSRP/SINR is not included. Further, c may represent a serving cell identifier where the report configuration is configured, and s may represent a report configuration identifier.

In some cases, such as in LTM procedures, the UE 115-a may independently determine to perform measurements (e.g., L1 measurements) for reference signals associated with a candidate serving cell (e.g., non-serving cell). The UE 115-a may accordingly generate an event triggered CSI report. In some cases, such CSI reports may not be associated with a network scheduled CSI report type (e.g., aperiodic, semi-persistent, periodic). However, the priority rule depicted in Equation 1 may not consider at least some conditions (e.g., conditions associated with LTM) such as candidate serving cell CSI reports 215 or event triggered CSI reports 215, among others. For instance, if a candidate serving cell CSI report 215 overlaps with a serving cell CSI report 215, or an event triggered CSI report 215 overlaps with another CSI report type, or multiple candidate serving cell CSI reports 215 overlap, the priority rule depicted in Equation 1 may not accurately prioritize the CSI reports 215.

According to techniques described herein, the wireless communications system 200 may utilize a priority rule that accounts for candidate serving cell CSI reports 215, event triggered CSI reports 215 (e.g., used in LTM procedures), among other conditions. In some examples, the priority rule may be based on a cell identifier where the CSI measurement is performed. In such examples, the priority rule may prioritize CSI reports 215 associated with the serving cell over CSI reports 215 associated with the candidate serving cell (e.g., serving cell>candidate serving cell or non-serving cell). When a report configuration of a CSI report 215 is associated with both the serving cell and one or more candidate serving cells, the UE 115-a may characterize the CSI report 215 as a serving cell CSI report 215. When multiple candidate serving cell CSI reports 215 overlap, the priority rule may prioritize the reports according to the cell identifier (e.g., ordered by the cell identifier). For example, multiple candidate serving cell CSI reports 215 may be ordered (e.g., prioritized) from a largest cell identifier to a smallest cell identifier or vice-versa.

In some examples, the UE 115-a may receive, from a network entity 105-a, control information message 205 that schedules the UE 115-a to transmit a set of CSI reports during overlapping windows of time, the set of CSI reports each based on measurements of respective sets of reference signals. The UE 115-a may then transmit, to the network entity 105-a and during the overlapping windows of time, a prioritized CSI report from the set of CSI reports in accordance with a priority rule (as depicted in Equation 2). The priority rule may define a priority of each of the set of CSI reports, where respective priorities corresponding to the plural set of CSI reports are based on the respective sets of reference signals being associated with a serving cell for the UE 115-a, one or more candidate serving cells for the UE 115-a, or both the serving cell for the UE 115-a and the one or more candidate serving cells for the UE 115-a.

The priority rule may include additional parameters or modify existing parameters to account for additional conditions when computing the priority metric. For example, to account for candidate serving cell CSI reports 215, event triggered CSI reports 215, LTM related conditions, and other conditions the priority metric may be determined according to Equation 2.

$${Pri}_{iCSI} ( y , k , c , s ) = ( 2 \cdot {N}_{cells} \cdot {M}_{s} \cdot y + {N}_{cells} \cdot {M}_{s} \cdot k + {M}_{s} \cdot c + s ) + z \cdot X \qquad ( 2 )$$

In the example of Equation 2, N_{cells}, Mₛ, k, and s may represent similar parameters as described with reference to Equation 1. Further, the parameter y may similarly account for the type of CSI report, but may additionally consider event triggered CSI reports 215. For example, values for y may be defined as follows: y=0 for aperiodic reports, y=1 for event triggered reports, y=2 for semi-persistent reports on PUSCH, y=3 for semi-persistent reports on PUCCH, and y=4 for periodic reports on PUCCH. The parameter c may represent a serving cell identifier that configures the report configuration, or may represent the smallest or largest candidate serving cell identifier that the report configuration is associated with. In some examples, the parameter X may be a defined term to distinguish CSI reports 215 carrying serving cell measurements and candidate serving cell measurements. For example, X may be defined as 9·N_{cells}·Mₛ+Mₛ, or as a maximum value a serving cell CSI report may achieve. The parameter z may represent whether the CSI report 215 is associated with the serving cell or the candidate serving cell (e.g., z may act as a flag). For example, values for z may be defined as follows: z=1 when the report configuration is associated with reference signals in the candidate serving cell and not associated with any reference signals in the serving cell, and z=0 when the report configuration is associated with one or more reference signals in the serving cell.

When generating a priority for a particular CSI report, the UE 115-a may determine the respective priorities for each of the set of CSI reports based on the priority rule depicted in Equation 2. In some examples, wherein the prioritized CSI report has a highest respective priority of the respective priorities. As depicted in the example of FIG. 2, the CSI report 215-a may have a higher respective priority than CSI report 215-b. The UE 115-a may weigh an input to the priority rule (using the factor z) based on whether the respective set of reference signals for a corresponding one of the set of CSI reports is associated with the serving cell for the UE 115-a, the one or more candidate serving cells for the UE 115-a, or both the serving cell for the UE 115-a and the one or more candidate serving cells for the UE 115-a.

As depicted in the example of Equation 2, the priority rule includes, as an input, a cell identifier associated with a respective one of the set of CSI reports, where the cell identifier is of the serving cell when the respective sets of reference signals are associated with the serving cell for the UE or associated with both the serving cell for the UE 115-a and the one or more candidate serving cells for the UE 115-a. Additionally, or alternatively, the priority rule includes, as an input, a cell identifier associated with a respective one of the set of CSI reports, where the cell identifier is of a one of the one or more candidate serving cells when the respective sets of reference signals are associated with only the one or more candidate serving cells for the UE 115-a. In some examples, a cell other than the serving cell may configure the report configuration for CSI report 215 to be included in a UCI. For instance, a deactivated serving cell or a candidate serving cell may configure the report configuration for the CSI report. The priority rule may further prioritize CSI reports based on the cell identifier where the report configuration associated with the CSI report is configured. For example, CSIs configured under the serving cell may have higher priority than CSIs with configured under a deactivated serving cell. Similarly, deactivated serving cell configured CSIs may have higher priority than CSIs configured under the candidate serving cell. For example, the CSI report 215-a may be associated with the serving cell and the CSI report 215-b may be associated a candidate serving cell. Thus, CSI report 215-a may be prioritized over CSI report 215-b and may be transmitted first to the network entity 105-a via measurement report 220. For instance, the UE 115-a or the network entity 105-a or both, may determine the prioritized CSI report based on the priority rule. In some cases, the priority rule assigns a greater weight to an input when the respective set of reference signals is associated with an active serving cell for the UE 115-a than when the respective set of reference signals is associated with a deactivated serving cell for the UE 115-a.

The priority rule may further be based on a type of CSI report 215 including event triggered CSI reports 215, among other considerations. For example, the priority rule may prioritize aperiodic reports over event triggered reports, and prioritize event triggered reports over semi-persistent reports, and prioritize semi-persistent reports over periodic reports (e.g., aperiodic reports>event triggered reports>semi-persistent reports>periodic reports). In some examples, the UE 115-a may determine the prioritized CSI report (e.g., CSI report 215-a) based on the priority rule depicted in Equation 2. The priority rule may assign a first weight to an input when the respective set of reference signals is associated with an aperiodic report type, a second weight to the input when the respective set of reference signals is associated with an event-triggered report type, a third weight to the input when the respective set of reference signals is associated with a semi-persistent report type, or a fourth weight to the input when the respective set of reference signals is associated with a periodic report type. In some examples, the first weight may be greater than the second weight, which may be greater than the third weight, which may be greater than the fourth weight.

In some examples, candidate serving cells may have different center frequency and tone spacing than the serving cell, and the UE 115-a may support multiple measurement types including intra-frequency measurement and inter-frequency measurement. The priority rule may prioritize the CSI reports 215 according to the measurement type. Specifically, the priority rule may prioritize intra-frequency measurements over inter-frequency measurements (e.g., intra-frequency measurement>inter-frequency measurement). For example, the priority rule may assign a greater weight to an input when the respective set of reference signals is associated with an intra-frequency measurement type than when the respective set of reference signals is associated with an inter-frequency measurement type. Additionally, or alternatively, a network entity 105-a (e.g., associated with a cell) may pre-configure the priority (e.g., configured in the report configuration for the CSI report 215). For example, the report configuration may indicate (e.g., assign) a priority metric or priority factor of the CSI report 215. Thus, the CSI report priority may be explicitly indicated (e.g., the network entity 105-a may indicate priority to the UE 115-a).

In some examples, a CSI report configuration (e.g., transmitted by a network entity 105-a) may be associated with a set of reference signals, where each reference signal may be for the serving cell or one or more candidate cells. The UE 115-a may select a subset of reference signals from the set of reference signals to perform CSI measurement and include in the CSI report 215. Additionally, or alternatively, one report configuration may be associated with reference signal measurements from multiple cells (e.g., serving cells and candidate serving cells). For example, the report configuration can be associated with RS1, RS2, . . . , RS5, but in a specific report, the UE 115-a may choose to report two reference signals having highest RSRPs, which can be any pair from (RS1-RS5). In such cases, the UE 115-a may compute the priority metric based on the associated reference signals, and not based on the reference signals that UE choose to carry in a report. However, the network entity 105-a may not know which reference signals of the set of reference signals were measured by the UE 115-a. Thus, the priority metric may be based on the set of reference signals associated with the CSI report configuration and not based on the subset of reference signals measured by the UE 115-a. In this way, the network entity 105-a may accurately perform a priority computation to determine a priority order of overlapping CSI reports 215.

In some examples, the UE 115-a may additionally, or alternatively, indicate, to the network entity 105-a, that the CSI report 215 is an event triggered report type. Indicating the event triggered CSI report type may improve the CSI report receiving procedures at the network entity 105-a. The network entity 105-a may perform blind decoding with different hypothesis, but such processes may be inaccurate in cases of overlapping CSI reports 215. For example, a periodic CSI report 215 and an event triggered CSI report 215 may have a same payload and a same format but may contain measurements for difference cells. Thus, the UE 115-a may include an indication (e.g., in a PUCCH) to indicate a prioritization result of a CSI report 215, or that the CSI report is an event triggered report. The UE 115-a transmit the indication via an explicit bit or field in the CSI report 215, via different scrambling sequences of a demodulation reference signal (DMRS), or via some other mechanism.

As an example, the UE 115-a may generate a CSI report 215-a and a CSI report 215-b based on the control information message 205 received from the network entity 105-a, or based on a triggering event (e.g., L1/L2 measurement, or other LTM event). The CSI report 215-a may be associated with a serving cell and the CSI report 215-b may be associated with a candidate serving cell and not associated with any reference signal in the serving cell. The CSI report 215-a and the CSI report 215-b may overlap in a time window 210, but the UE 115-a may be constrained to transmit a single CSI report 215 at a time. Thus, the UE 115-a, the network entity 105-a, or both, may determine a priority for each CSI report 215 according to the priority rule as described herein, which may account for candidate serving cell CSI reports 215. That is, the UE 115-a, the network entity 105-a, or both may compute a first priority metric for CSI report 215-a and a second priority metric for CSI report 215-b. Because the CSI report 215-a is associated with the serving cell and the CSI report 215-b is not associated with the serving cell, the first priority metric may be lower than the second priority metric, indicating that CSI report 215-a has higher priority than CSI report 215-b. Thus, the 115-a may select to transmit CSI report 215-a in a measurement report (e.g., measurement report 220). The UE 115-a may determine to drop the transmission of the CSI report 215-b or may temporarily postpone the transmission of the CSI report 215-b for a duration. Other examples of overlapping CSI reports 215 with various configurations, including LTM related configurations, are contemplated, and the prioritization of the overlapping CSI reports 215 may be similarly determined according to the techniques described herein.

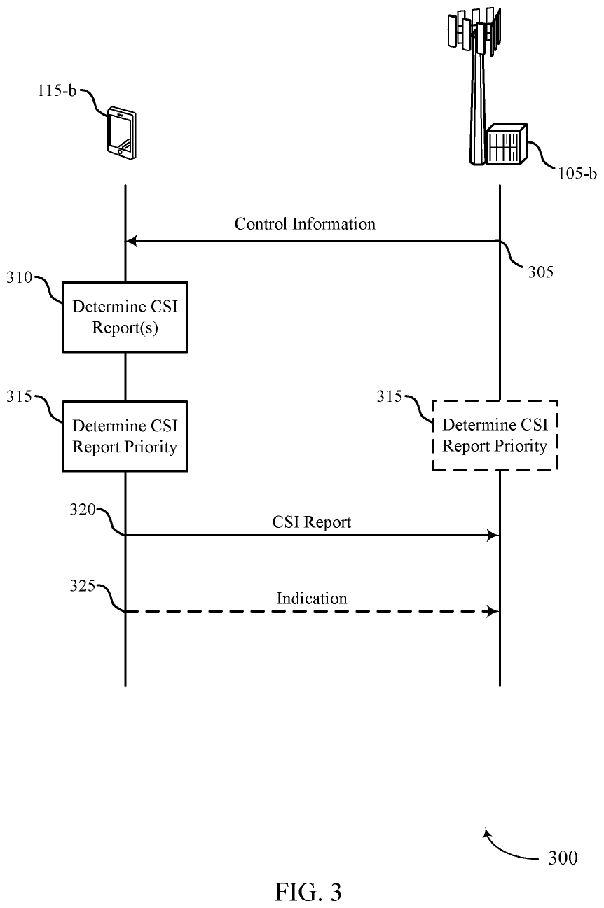

FIG. 3 shows an example of a process flow 300 that supports techniques to determine a priority of a CSI report in accordance with one or more aspects of the present disclosure. The process flow 300 may implement or be implemented by aspects of the wireless communications systems 100 and 200. For example, a UE 115-b and a network entity 105-b may implement the process flow 300 to employ a more robust UCI report (e.g., and CSI report) prioritization procedure, which may further improve cell switching procedures (e.g., LTM procedures). The UE 115-b and the network entity 105-b may represent aspects of corresponding devices as described with reference to FIGS. 1 and 2. In some aspects, the prioritization procedure may include considerations of additional or modified parameters when determining priority of CSI reports. In the following description of the process flow 300, the operations between the UE 115-b and the network entity 105-b may be performed in different orders or at different times. Some operations may also be left out of the process flow 300, or other operations may be added. Although the UE 115-b and the network entity 105-b are shown performing the operations of the process flow 300, some aspects of some operations may also be performed by one or more other wireless devices.

At 305, the UE 115-b may receive, from the network entity 105-b (e.g., the network entity 105-b may transmit), a control information message that schedules the UE 115-b to transmit a set CSI reports. In some examples, the one or more CSI reports may be scheduled to transmit during overlapping windows of time. For example, the control information may indicate a set of reference signals for the UE 115-b to measure and transmit a CSI report in response. The control information may further include information such as a report configuration (e.g., for a CSI report), a report configuration identifier, a cell identifier, a serving cell index, or some other control information.

At 310, the UE 115-b may perform one or more measurements (e.g., of reference signals indicated at 305) to determine information for the set of CSI reports. That is, the set of CSI reports may be based on measurements of respective sets of reference signals. For example, the UE 115-b may determine a first CSI report corresponding to a first set of reference signals, where the first set of reference signals is associated with a serving cell for the UE 115-b. The UE 115-b may determine a second CSI report corresponding to a second set of reference signals, where the second set of reference signals is associated with a candidate serving cell for the UE 115-b.

At 315, the UE 115-b, the network entity 105-b, or both may determine a CSI report priority in accordance with a priority rule. For example, the priority rule may define a priority of each of the set of CSI reports. In some examples, respective priorities corresponding to the set of CSI reports may be based on the respective sets of reference signals being associated with a serving cell for the UE 115-b, one or more candidate serving cells for the UE 115-b, or both the serving cell for the UE 115-b and the one or more candidate serving cells for the UE 115-b. In some examples, a prioritized CSI report may have a highest respective priority of the respective priorities. The priority rule may be associated with a priority metric calculation (e.g., calculation according to Equation 2 as described with reference to FIG. 2).

In some examples, the priority rule may include, as an input, a cell identifier associated with a respective one of the set of CSI reports. The cell identifier may be of the serving cell when the respective sets of reference signals are associated with the serving cell for the UE 115-b or associated with both the serving cell for the UE 115-b and the one or more candidate serving cells for the UE 115-b. That is, the cell identifier may be associated with the serving cell if any of the respective sets of reference signals are associated with the serving cell. In some other examples, the cell identifier may be of a one of the one or more candidate serving cells when the respective sets of reference signals are associated with only the one or more candidate serving cells for the UE 115-b. That is, the cell identifier may be associated with one of the one or more candidate serving cells if none of the respective sets of reference signals are associated with the serving cell. In some examples, the one of the one or more candidate serving cells may have either a smallest cell identifier of the one or more candidate serving cells or a largest cell identifier of the one or more candidate serving cells.

In some examples, the UE 115-b, the network entity 105-b, or both may weigh an input to the priority rule based on whether the respective set of reference signals for a corresponding one of the set of CSI reports is associated with the serving cell for the UE 115-b, the one or more candidate serving cells for the UE 115-b, or both the serving cell for the UE 115-b and the one or more candidate serving cells for the UE 115-b. For example, the input may be assigned a greater weight when the respective set of reference signals is associated with the serving cell for the UE 115-b than when the respective set of reference signals is associated with only the one or more candidate serving cells for the UE 115-b.

The UE 115-b, the network entity 105-b, or both may determine a prioritized CSI report based on the priority rule. The priority rule may assign a greater weight to an input when the respective set of reference signals is associated with an active serving cell for the UE 115-b than when the respective set of reference signals is associated with a deactivated serving cell for the UE 115-b. The priority rule may further assign a greater weight to the input when the respective set of reference signals is associated with the deactivated serving cell for the UE 115-b than when the respective set of reference signals is associated with only the candidate serving cell for the UE 115-b. That is, CSI reports associated with the active serving cell may have higher priority than CSI reports associated with a deactivated serving cell, and CSI reports associated with a deactivated serving cell may have higher priority than CSI reports associated with a candidate serving cell. The priority rule may also assign a greater weight to an input when the respective set of reference signals is associated with an intra-frequency measurement type than when the respective set of reference signals is associated inter-frequency measurement type. Thus, CSI reports associated with the intra-frequency measurement type may be prioritized over CSI reports associated with an inter-frequency measurement type.

The priority rule may further assign a first weight to an input when the respective set of reference signals is associated with an aperiodic report type, a second weight to the input when the respective set of reference signals is associated with an event-triggered report type (e.g., LTM report, L1 measurement report), a third weight to the input when the respective set of reference signals is associated with a semi-persistent report type, or a fourth weight to the input when the respective set of reference signals is associated with a periodic report type. In some examples, the first weight may be greater than the second weight, which may be greater than the third weight, which may be greater than the fourth weight.

In some examples, parameters of the priority rule (e.g., parameters of Equation 2 as described with reference to FIG. 2) may include at least one of a type of measurement report, an indication of whether a RSRP value or a SINR value is included in a corresponding one of the set of CSI reports, a serving cell index, a maximum number of serving cells, a report identifier for the CSI report, a maximum number of CSI report indications, an input distinguishing CSI reports carrying serving cell measurement and candidate serving cell measurement, a term having a first value indicating that the set of CSI reports is not associated with any reference signal in the serving cell, where the term has a second value indicating that the set of CSI reports is not associated with a reference signal in the serving cell, or a combination thereof.

At 320, the UE 115-b may transmit, to the network entity 105-b (e.g., the network entity 105-b may receive), during overlapping windows of time (e.g., during a window of time where a first CSI report and second CSI report overlap), the prioritized CSI report from the set of CSI reports in accordance with a priority rule. In some examples, the prioritized CSI report may be associated with a highest respective priority of a set of priorities (e.g., determined at 315) associated with the set of CSI reports. For example, the UE 115-b may determine a first CSI report corresponding to a first set of reference signals, where the first set of reference signals is associated with a serving cell for the UE 115-b. The UE 115-b may determine a second CSI report corresponding to a second set of reference signals, where the second set of reference signals is associated with a candidate serving cell for the UE 115-b. Accordingly, the UE 115-b may transmit the first CSI report in accordance with the priority rule as the prioritized CSI report, prioritizing the serving cell for the UE 115-b over the candidate serving cell for the UE 115-b.

At 325, in some examples, the UE 115-b may transmit, to the network entity 105-b (e.g., the network entity 105-b may receive), an indication indicating whether the prioritized CSI report is triggered based on a mobility event (e.g., LTM event, L1 measurement, L2 measurement) at the UE 115-b. In some examples, the indication may be transmitted using at least one of an explicit bit in the prioritized CSI report at 325, a field in the prioritized CSI report at 325, one or more scrambling sequences of a DMRS, or a combination thereof.

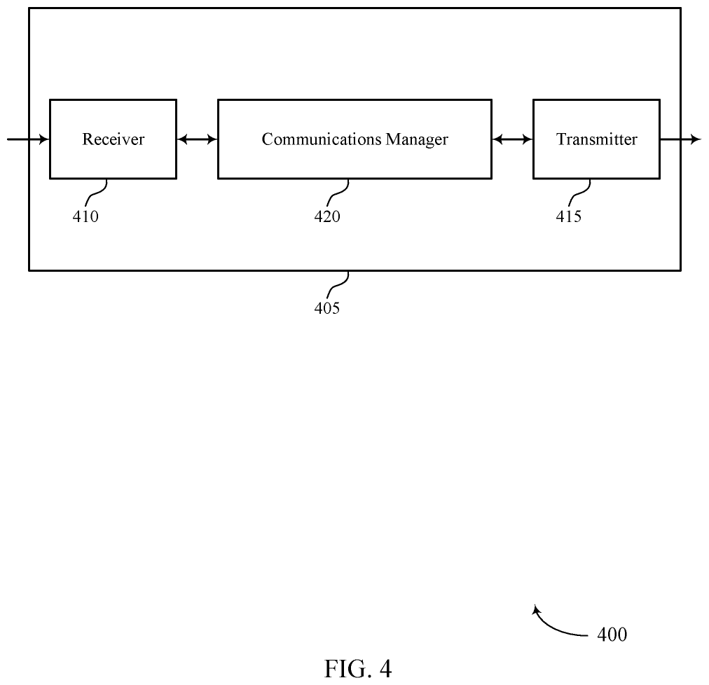

FIG. 4 shows a block diagram 400 of a device 405 that supports techniques to determine a priority of a CSI report in accordance with one or more aspects of the present disclosure. The device 405 may be an example of aspects of a UE 115 as described herein. The device 405 may include a receiver 410, a transmitter 415, and a communications manager 420. The device 405 may also include a processor. Each of these components may be in communication with one another (e.g., via one or more buses).

The receiver 410 may provide a means for receiving information such as packets, user data, control information, or any combination thereof associated with various information channels (e.g., control channels, data channels, information channels related to techniques to determine a priority of a CSI report). Information may be passed on to other components of the device 405. The receiver 410 may utilize a single antenna or a set of multiple antennas.

The transmitter 415 may provide a means for transmitting signals generated by other components of the device 405. For example, the transmitter 415 may transmit information such as packets, user data, control information, or any combination thereof associated with various information channels (e.g., control channels, data channels, information channels related to techniques to determine a priority of a CSI reports). In some examples, the transmitter 415 may be co-located with a receiver 410 in a transceiver module. The transmitter 415 may utilize a single antenna or a set of multiple antennas.

The communications manager 420, the receiver 410, the transmitter 415, or various combinations thereof or various components thereof may be examples of means for performing various aspects of techniques to determine a priority of a CSI report as described herein. For example, the communications manager 420, the receiver 410, the transmitter 415, or various combinations or components thereof may support a method for performing one or more of the functions described herein.

In some examples, the communications manager 420, the receiver 410, the transmitter 415, or various combinations or components thereof may be implemented in hardware (e.g., in communications management circuitry). The hardware may include a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 420, the receiver 410, the transmitter 415, or various combinations or components thereof may be implemented in code (e.g., as communications management software or firmware) executed by a processor. If implemented in code executed by a processor, the functions of the communications manager 420, the receiver 410, the transmitter 415, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 420 may be configured to perform various operations (e.g., receiving, obtaining, monitoring, outputting, transmitting) using or otherwise in cooperation with the receiver 410, the transmitter 415, or both. For example, the communications manager 420 may receive information from the receiver 410, send information to the transmitter 415, or be integrated in combination with the receiver 410, the transmitter 415, or both to obtain information, output information, or perform various other operations as described herein.

The communications manager 420 may support wireless communications at a UE in accordance with examples as disclosed herein. For example, the communications manager 420 is capable of, configured to, or operable to support a means for receiving, from a network entity, control information that schedules the UE to transmit a set of multiple CSI reports during overlapping windows of time, the set of multiple CSI reports each based on measurements of respective sets of reference signals. The communications manager 420 is capable of, configured to, or operable to support a means for transmitting, to the network entity and during the overlapping windows of time, a prioritized CSI report from the set of multiple CSI reports in accordance with a priority rule, where the priority rule defines a priority of each of the set of multiple CSI reports, where respective priorities corresponding to the set of multiple CSI reports are based on the respective sets of reference signals being associated with a serving cell for the UE, one or more candidate serving cells for the UE, or both the serving cell for the UE and the one or more candidate serving cells for the UE.

By including or configuring the communications manager 420 in accordance with examples as described herein, the device 405 (e.g., a processor controlling or otherwise coupled with the receiver 410, the transmitter 415, the communications manager 420, or a combination thereof) may support techniques for reduced processing, reduced power consumption, more efficient utilization of communication resources, and more robust CSI reporting procedures.

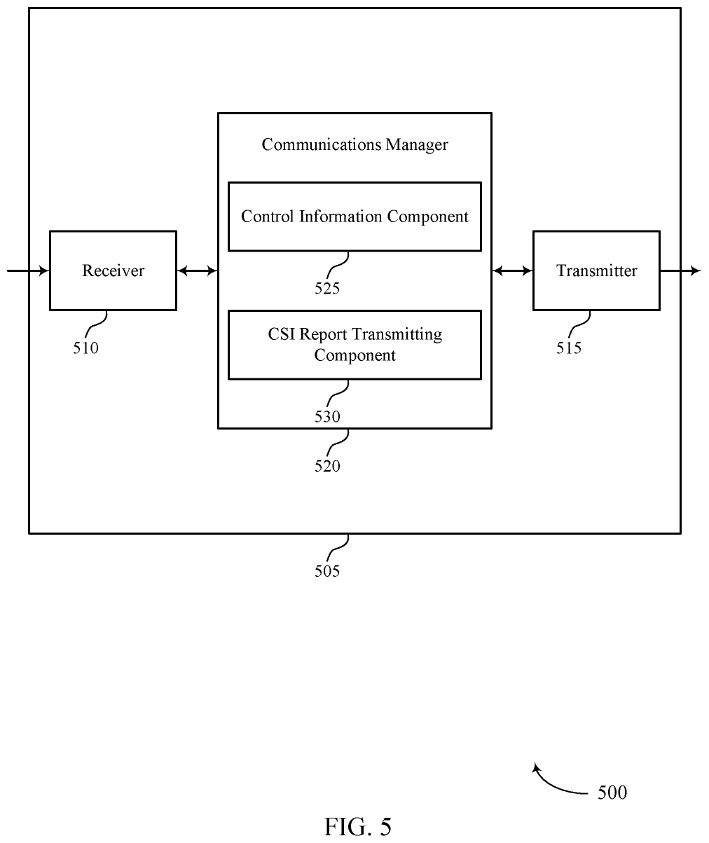

FIG. 5 shows a block diagram 500 of a device 505 that supports techniques to determine a priority of a CSI report in accordance with one or more aspects of the present disclosure. The device 505 may be an example of aspects of a device 405 or a UE 115 as described herein. The device 505 may include a receiver 510, a transmitter 515, and a communications manager 520. The device 505 may also include a processor. Each of these components may be in communication with one another (e.g., via one or more buses).

The receiver 510 may provide a means for receiving information such as packets, user data, control information, or any combination thereof associated with various information channels (e.g., control channels, data channels, information channels related to techniques to determine a priority of a CSI report). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to techniques to determine a priority of a CSI report). In some examples, the transmitter 515 may be co-located with a receiver 510 in a transceiver module. The transmitter 515 may utilize a single antenna or a set of multiple antennas.

The device 505, or various components thereof, may be an example of means for performing various aspects of techniques to determine a priority of a CSI report as described herein. For example, the communications manager 520 may include a control information component 525 a CSI report transmitting component 530, or any combination thereof. The communications manager 520 may be an example of aspects of a communications manager 420 as described herein. In some examples, the communications manager 520, or various components thereof, may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support wireless communications at a UE in accordance with examples as disclosed herein. The control information component 525 is capable of, configured to, or operable to support a means for receiving, from a network entity, control information that schedules the UE to transmit a set of multiple CSI reports during overlapping windows of time, the set of multiple CSI reports each based on measurements of respective sets of reference signals. The CSI report transmitting component 530 is capable of, configured to, or operable to support a means for transmitting, to the network entity and during the overlapping windows of time, a prioritized CSI report from the set of multiple CSI reports in accordance with a priority rule, where the priority rule defines a priority of each of the set of multiple CSI reports, where respective priorities corresponding to the set of multiple CSI reports are based on the respective sets of reference signals being associated with a serving cell for the UE, one or more candidate serving cells for the UE, or both the serving cell for the UE and the one or more candidate serving cells for the UE.

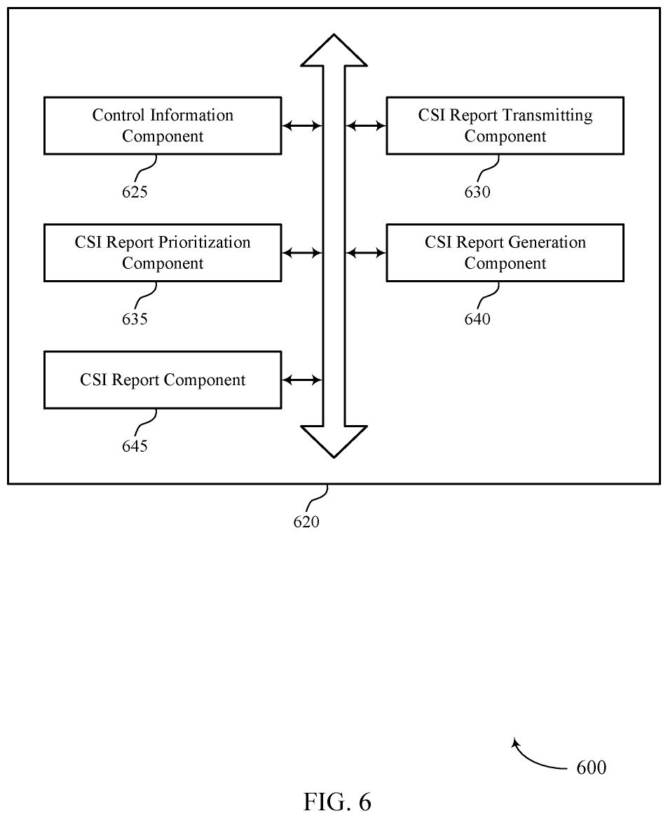

FIG. 6 shows a block diagram 600 of a communications manager 620 that supports techniques to determine a priority of a CSI report in accordance with one or more aspects of the present disclosure. The communications manager 620 may be an example of aspects of a communications manager 420, a communications manager 520, or both, as described herein. The communications manager 620, or various components thereof, may be an example of means for performing various aspects of techniques to determine a priority of a CSI report as described herein. For example, the communications manager 620 may include a control information component 625, a CSI report transmitting component 630, a CSI report prioritization component 635, a CSI report generation component 640, a CSI report component 645, or any combination thereof. Each of these components may communicate, directly or indirectly, with one another (e.g., via one or more buses).

The communications manager 620 may support wireless communications at a UE in accordance with examples as disclosed herein. The control information component 625 is capable of, configured to, or operable to support a means for receiving, from a network entity, control information that schedules the UE to transmit a set of multiple CSI reports during overlapping windows of time, the set of multiple CSI reports each based on measurements of respective sets of reference signals. The CSI report transmitting component 630 is capable of, configured to, or operable to support a means for transmitting, to the network entity and during the overlapping windows of time, a prioritized CSI report from the set of multiple CSI reports in accordance with a priority rule, where the priority rule defines a priority of each of the set of multiple CSI reports, where respective priorities corresponding to the set of multiple CSI reports are based on the respective sets of reference signals being associated with a serving cell for the UE, one or more candidate serving cells for the UE, or both the serving cell for the UE and the one or more candidate serving cells for the UE.

In some examples, the CSI report prioritization component 635 is capable of, configured to, or operable to support a means for determining the respective priorities for each of the set of multiple CSI reports based on the priority rule, where the prioritized CSI report has a highest respective priority of the respective priorities.

In some examples, the CSI report prioritization component 635 is capable of, configured to, or operable to support a means for weighting an input to the priority rule based on whether the respective set of reference signals for a corresponding one of the set of multiple CSI reports is associated with the serving cell for the UE, the one or more candidate serving cells for the UE, or both the serving cell for the UE and the one or more candidate serving cells for the UE.

In some examples, the input is assigned a greater weight when the respective set of reference signals is associated with the serving cell for the UE than when the respective set of reference signals is associated with only the one or more candidate serving cells for the UE.

In some examples, the priority rule includes, as an input, a cell identifier associated with a respective one of the set of multiple CSI reports. In some examples, the cell identifier is of the serving cell when the respective sets of reference signals are associated with the serving cell for the UE or associated with both the serving cell for the UE and the one or more candidate serving cells for the UE.

In some examples, the priority rule includes, as an input, a cell identifier associated with a respective one of the set of multiple CSI reports. In some examples, the cell identifier is of a one of the one or more candidate serving cells when the respective sets of reference signals are associated with only the one or more candidate serving cells for the UE. In some examples, the one of the one or more candidate serving cells has either a smallest cell identifier of the one or more candidate serving cells or a largest cell identifier of the one or more candidate serving cells.

In some examples, the CSI report prioritization component 635 is capable of, configured to, or operable to support a means for determining the prioritized CSI report based on the priority rule, where the priority rule assigns a greater weight to an input when the respective set of reference signals is associated with an active serving cell for the UE than when the respective set of reference signals is associated with a deactivated serving cell for the UE.

In some examples, the priority rule assigns a greater weight to the input when the respective set of reference signals is associated with the deactivated serving cell for the UE than when the respective set of reference signals is associated with only a candidate serving cell for the UE.

In some examples, the CSI report prioritization component 635 is capable of, configured to, or operable to support a means for determining the prioritized CSI report based on the priority rule, where the priority rule assigns a greater weight to an input when the respective set of reference signals is associated with an intra-frequency measurement type than when the respective set of reference signals is associated with an inter-frequency measurement type.

In some examples, the CSI report prioritization component 635 is capable of, configured to, or operable to support a means for determining the prioritized CSI report based on the priority rule, where the priority rule assigns a first weight to an input when the respective set of reference signals is associated with an aperiodic report type, a second weight to the input when the respective set of reference signals is associated with an event-triggered report type, a third weight to the input when the respective set of reference signals is associated with a semi-persistent report type, or a fourth weight to the input when the respective set of reference signals is associated with a periodic report type, where the first weight is greater than the second weight, which is greater than the third weight, which is greater than the fourth weight.

In some examples, the CSI report generation component 640 is capable of, configured to, or operable to support a means for determining a first CSI report corresponding to a first set of reference signals, where the first set of reference signals is associated with the serving cell for the UE. In some examples, the CSI report component 645 is capable of, configured to, or operable to support a means for determining a second CSI report corresponding to a second set of reference signals, where the second set of reference signals is associated with a candidate serving cell for the UE, and where transmitting the prioritized CSI report includes transmitting the first CSI report in accordance with the priority rule prioritizing the serving cell for the UE over the candidate serving cell for the UE.

In some examples, parameters of the priority rule include at least one of a type of measurement report, an indication of whether a reference signal received power value or a signal to noise ratio value is included in a corresponding one of the set of multiple CSI reports, a serving cell index, a maximum number of serving cells, a report identifier for a CSI report, a maximum number of CSI report indications, an input distinguishing CSI reports carrying serving cell measurement and candidate cell measurement, a term having a first value indicating that the set of multiple CSI reports is not associated with any reference signal in the serving cell. In some examples, the term has a second value indicating that the set of multiple CSI reports is associated with a reference signal in the serving cell, or a combination thereof.

In some examples, the CSI report transmitting component 630 is capable of, configured to, or operable to support a means for transmitting, to the network entity, an indication indicating whether the prioritized CSI report is triggered based on a mobility event at the UE.

In some examples, the indication is transmitted using at least one of an explicit bit in the prioritized CSI report, a field in the prioritized CSI report, one or more scrambling sequences of a demodulation reference signal, or a combination thereof.

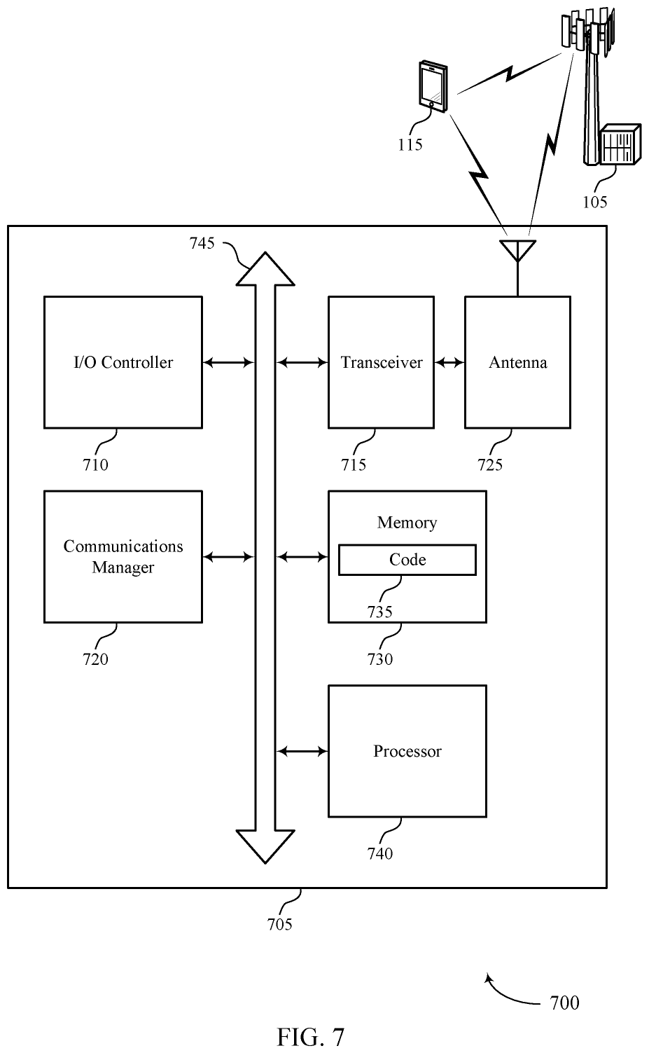

FIG. 7 shows a diagram of a system 700 including a device 705 that supports techniques to determine a priority of a CSI report in accordance with one or more aspects of the present disclosure. The device 705 may be an example of or include the components of a device 405, a device 505, or a UE 115 as described herein. The device 705 may communicate (e.g., wirelessly) with one or more network entities 105, one or more UEs 115, or any combination thereof. The device 705 may include components for bi-directional voice and data communications including components for transmitting and receiving communications, such as a communications manager 720, an input/output (I/O) controller 710, a transceiver 715, an antenna 725, a memory 730, code 735, and a processor 740. These components may be in electronic communication or otherwise coupled (e.g., operatively, communicatively, functionally, electronically, electrically) via one or more buses (e.g., a bus 745).

The I/O controller 710 may manage input and output signals for the device 705. The I/O controller 710 may also manage peripherals not integrated into the device 705. In some cases, the I/O controller 710 may represent a physical connection or port to an external peripheral. In some cases, the I/O controller 710 may utilize an operating system such as iOS®, ANDROID®, MS-DOS®, MS-WINDOWS®, OS/2®, UNIX®, LINUX®, or another known operating system. Additionally, or alternatively, the I/O controller 710 may represent or interact with a modem, a keyboard, a mouse, a touchscreen, or a similar device. In some cases, the I/O controller 710 may be implemented as part of a processor, such as the processor 740. In some cases, a user may interact with the device 705 via the I/O controller 710 or via hardware components controlled by the I/O controller 710.

In some cases, the device 705 may include a single antenna 725. However, in some other cases, the device 705 may have more than one antenna 725, which may be capable of concurrently transmitting or receiving multiple wireless transmissions. The transceiver 715 may communicate bi-directionally, via the one or more antennas 725, wired, or wireless links as described herein. For example, the transceiver 715 may represent a wireless transceiver and may communicate bi-directionally with another wireless transceiver. The transceiver 715 may also include a modem to modulate the packets, to provide the modulated packets to one or more antennas 725 for transmission, and to demodulate packets received from the one or more antennas 725. The transceiver 715, or the transceiver 715 and one or more antennas 725, may be an example of a transmitter 415, a transmitter 515, a receiver 410, a receiver 510, or any combination thereof or component thereof, as described herein.

The memory 730 may include random access memory (RAM) and read-only memory (ROM). The memory 730 may store computer-readable, computer-executable code 735 including instructions that, when executed by the processor 740, cause the device 705 to perform various functions described herein. The code 735 may be stored in a non-transitory computer-readable medium such as system memory or another type of memory. In some cases, the code 735 may not be directly executable by the processor 740 but may cause a computer (e.g., when compiled and executed) to perform functions described herein. In some cases, the memory 730 may contain, among other things, a basic I/O system (BIOS) which may control basic hardware or software operation such as the interaction with peripheral components or devices.

The processor 740 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 740 may be configured to operate a memory array using a memory controller. In some other cases, a memory controller may be integrated into the processor 740. The processor 740 may be configured to execute computer-readable instructions stored in a memory (e.g., the memory 730) to cause the device 705 to perform various functions (e.g., functions or tasks supporting techniques to determine a priority of a CSI report). For example, the device 705 or a component of the device 705 may include a processor 740 and memory 730 coupled with or to the processor 740, the processor 740 and memory 730 configured to perform various functions described herein.

The communications manager 720 may support wireless communications at a UE in accordance with examples as disclosed herein. For example, the communications manager 720 is capable of, configured to, or operable to support a means for receiving, from a network entity, control information that schedules the UE to transmit a set of multiple CSI reports during overlapping windows of time, the set of multiple CSI reports each based on measurements of respective sets of reference signals. The communications manager 720 is capable of, configured to, or operable to support a means for transmitting, to the network entity and during the overlapping windows of time, a prioritized CSI report from the set of multiple CSI reports in accordance with a priority rule, where the priority rule defines a priority of each of the set of multiple CSI reports, where respective priorities corresponding to the set of multiple CSI reports are based on the respective sets of reference signals being associated with a serving cell for the UE, one or more candidate serving cells for the UE, or both the serving cell for the UE and the one or more candidate serving cells for the UE.

By including or configuring the communications manager 720 in accordance with examples as described herein, the device 705 may support techniques for improved communication reliability, reduced latency (e.g., in LTM procedures, in handover procedures), more efficient utilization of communication resources, and improved coordination between devices.

In some examples, the communications manager 720 may be configured to perform various operations (e.g., receiving, monitoring, transmitting) using or otherwise in cooperation with the transceiver 715, the one or more antennas 725, or any combination thereof. Although the communications manager 720 is illustrated as a separate component, in some examples, one or more functions described with reference to the communications manager 720 may be supported by or performed by the processor 740, the memory 730, the code 735, or any combination thereof. For example, the code 735 may include instructions executable by the processor 740 to cause the device 705 to perform various aspects of techniques to determine a priority of a CSI report as described herein, or the processor 740 and the memory 730 may be otherwise configured to perform or support such operations.

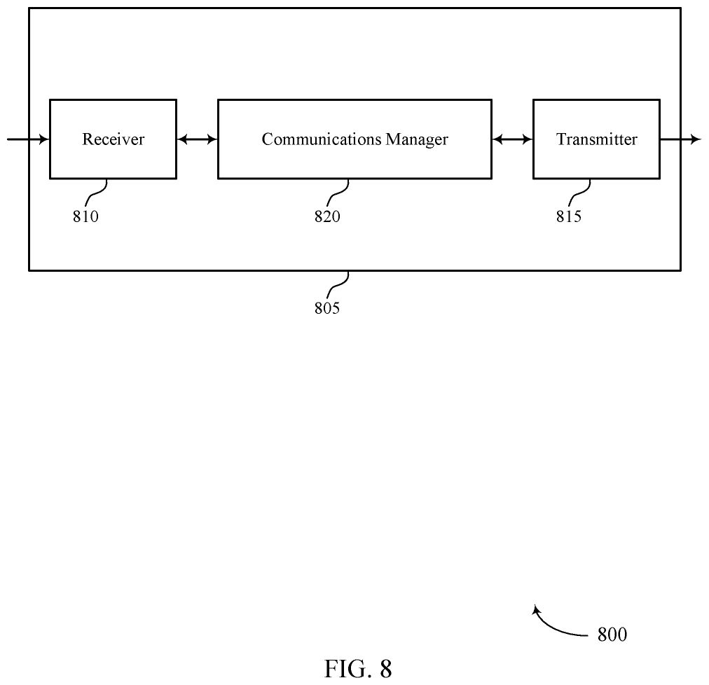

FIG. 8 shows a block diagram 800 of a device 805 that supports techniques to determine a priority of a CSI report in accordance with one or more aspects of the present disclosure. The device 805 may be an example of aspects of a network entity 105 as described herein. The device 805 may include a receiver 810, a transmitter 815, and a communications manager 820. The device 805 may also include a processor. Each of these components may be in communication with one another (e.g., via one or more buses).

The receiver 810 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 805. In some examples, the receiver 810 may support obtaining information by receiving signals via one or more antennas. Additionally, or alternatively, the receiver 810 may support obtaining information by receiving signals via one or more wired (e.g., electrical, fiber optic) interfaces, wireless interfaces, or any combination thereof.

The transmitter 815 may provide a means for outputting (e.g., transmitting, providing, conveying, sending) information generated by other components of the device 805. For example, the transmitter 815 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 815 may support outputting information by transmitting signals via one or more antennas. Additionally, or alternatively, the transmitter 815 may support outputting information by transmitting signals via one or more wired (e.g., electrical, fiber optic) interfaces, wireless interfaces, or any combination thereof. In some examples, the transmitter 815 and the receiver 810 may be co-located in a transceiver, which may include or be coupled with a modem.

The communications manager 820, the receiver 810, the transmitter 815, or various combinations thereof or various components thereof may be examples of means for performing various aspects of techniques to determine a priority of a CSI report as described herein. For example, the communications manager 820, the receiver 810, the transmitter 815, or various combinations or components thereof may support a method for performing one or more of the functions described herein.

In some examples, the communications manager 820, the receiver 810, the transmitter 815, or various combinations or components thereof may be implemented in hardware (e.g., in communications management circuitry). The hardware may include a processor, a DSP, a CPU, an ASIC, an FPGA or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 820, the receiver 810, the transmitter 815, or various combinations or components thereof may be implemented in code (e.g., as communications management software or firmware) executed by a processor. If implemented in code executed by a processor, the functions of the communications manager 820, the receiver 810, the transmitter 815, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 820 may be configured to perform various operations (e.g., receiving, obtaining, monitoring, outputting, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to obtain information, output information, or perform various other operations as described herein.

The communications manager 820 may support wireless communications at a network entity in accordance with examples as disclosed herein. For example, the communications manager 820 is capable of, configured to, or operable to support a means for transmitting, to a UE, control information that schedules the UE to transmit a set of multiple CSI reports during overlapping windows of time, the set of multiple CSI reports each based on measurements of respective sets of reference signals. The communications manager 820 is capable of, configured to, or operable to support a means for receiving, from the UE and during the overlapping windows of time, a prioritized CSI report from the set of multiple CSI reports in accordance with a priority rule, where the priority rule defines a priority of each of the set of multiple CSI reports, where respective priorities corresponding to the set of multiple CSI reports are based on the respective sets of reference signals being associated with a serving cell for the UE, one or more candidate serving cells for the UE, or both the serving cell for the UE and the one or more candidate serving cells for the UE.

By including or configuring the communications manager 820 in accordance with examples as described herein, the device 805 (e.g., a processor controlling or otherwise coupled with the receiver 810, the transmitter 815, the communications manager 820, or a combination thereof) may support techniques for reduced processing, reduced power consumption, more efficient utilization of communication resources, and more robust CSI reporting procedures.

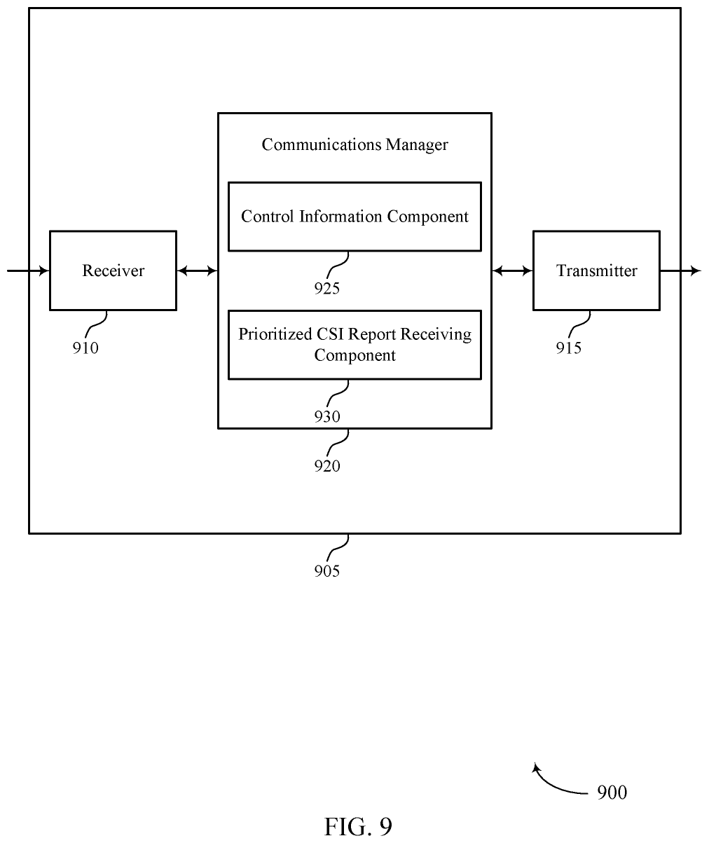

FIG. 9 shows a block diagram 900 of a device 905 that supports techniques to determine a priority of a CSI report in accordance with one or more aspects of the present disclosure. The device 905 may be an example of aspects of a device 805 or a network entity 105 as described herein. The device 905 may include a receiver 910, a transmitter 915, and a communications manager 920. The device 905 may also include a processor. Each of these components may be in communication with one another (e.g., via one or more buses).

The receiver 910 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 905. In some examples, the receiver 910 may support obtaining information by receiving signals via one or more antennas. Additionally, or alternatively, the receiver 910 may support obtaining information by receiving signals via one or more wired (e.g., electrical, fiber optic) interfaces, wireless interfaces, or any combination thereof.

The transmitter 915 may provide a means for outputting (e.g., transmitting, providing, conveying, sending) information generated by other components of the device 905. For example, the transmitter 915 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 915 may support outputting information by transmitting signals via one or more antennas. Additionally, or alternatively, the transmitter 915 may support outputting information by transmitting signals via one or more wired (e.g., electrical, fiber optic) interfaces, wireless interfaces, or any combination thereof. In some examples, the transmitter 915 and the receiver 910 may be co-located in a transceiver, which may include or be coupled with a modem.

The device 905, or various components thereof, may be an example of means for performing various aspects of techniques to determine a priority of a CSI report as described herein. For example, the communications manager 920 may include a control information component 925 a prioritized CSI report receiving component 930, or any combination thereof. The communications manager 920 may be an example of aspects of a communications manager 820 as described herein. In some examples, the communications manager 920, or various components thereof, may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communications at a network entity in accordance with examples as disclosed herein. The control information component 925 is capable of, configured to, or operable to support a means for transmitting, to a UE, control information that schedules the UE to transmit a set of multiple CSI reports during overlapping windows of time, the set of multiple CSI reports each based on measurements of respective sets of reference signals. The prioritized CSI report receiving component 930 is capable of, configured to, or operable to support a means for receiving, from the UE and during the overlapping windows of time, a prioritized CSI report from the set of multiple CSI reports in accordance with a priority rule, where the priority rule defines a priority of each of the set of multiple CSI reports, where respective priorities corresponding to the set of multiple CSI reports are based on the respective sets of reference signals being associated with a serving cell for the UE, one or more candidate serving cells for the UE, or both the serving cell for the UE and the one or more candidate serving cells for the UE.

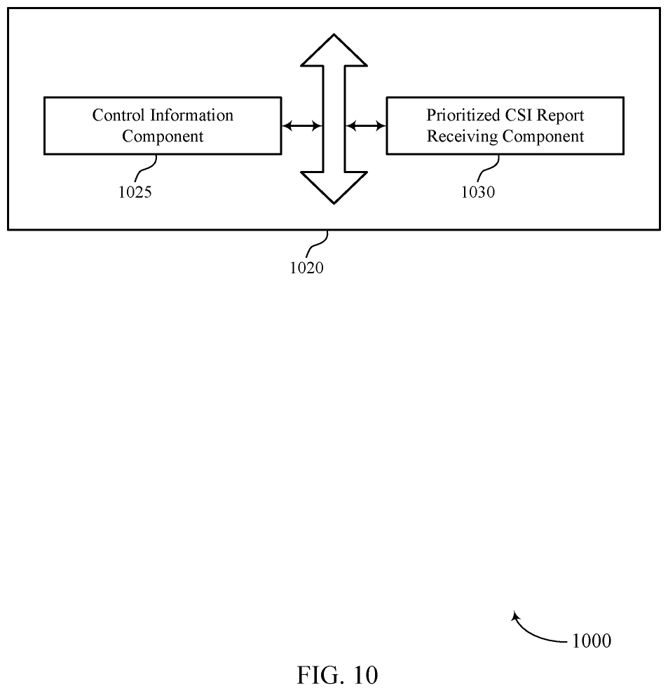

FIG. 10 shows a block diagram 1000 of a communications manager 1020 that supports techniques to determine a priority of a CSI report in accordance with one or more aspects of the present disclosure. The communications manager 1020 may be an example of aspects of a communications manager 820, a communications manager 920, or both, as described herein. The communications manager 1020, or various components thereof, may be an example of means for performing various aspects of techniques to determine a priority of a CSI report as described herein. For example, the communications manager 1020 may include a control information component 1025 a prioritized CSI report receiving component 1030, or any combination thereof. Each of these components may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1020 may support wireless communications at a network entity in accordance with examples as disclosed herein. The control information component 1025 is capable of, configured to, or operable to support a means for transmitting, to a UE, control information that schedules the UE to transmit a set of multiple CSI reports during overlapping windows of time, the set of multiple CSI reports each based on measurements of respective sets of reference signals. The prioritized CSI report receiving component 1030 is capable of, configured to, or operable to support a means for receiving, from the UE and during the overlapping windows of time, a prioritized CSI report from the set of multiple CSI reports in accordance with a priority rule, where the priority rule defines a priority of each of the set of multiple CSI reports, where respective priorities corresponding to the set of multiple CSI reports are based on the respective sets of reference signals being associated with a serving cell for the UE, one or more candidate serving cells for the UE, or both the serving cell for the UE and the one or more candidate serving cells for the UE.

In some examples, the priority rule indicates that the prioritized CSI report has a highest respective priority of the respective priorities.

In some examples, the priority rule indicates that an input to the priority rule is weighed based on whether the respective set of reference signals for a corresponding one of the set of multiple CSI reports is associated with the serving cell for the UE, the one or more candidate serving cells for the UE, or both the serving cell for the UE and the one or more candidate serving cells for the UE.

In some examples, the input is assigned a greater weight when the respective set of reference signals is associated with the serving cell for the UE than when the respective set of reference signals is associated with only the one or more candidate serving cells for the UE.

In some examples, the priority rule includes, as an input, a cell identifier associated with a respective one of the set of multiple CSI reports. In some examples, the cell identifier is of the serving cell when the respective sets of reference signals are associated with the serving cell for the UE or associated with both the serving cell for the UE and the one or more candidate serving cells for the UE.

In some examples, the priority rule includes, as an input, a cell identifier associated with a respective one of the set of multiple CSI reports. In some examples, the cell identifier is of a one of the one or more candidate serving cells when the respective sets of reference signals are associated with only the one or more candidate serving cells for the UE.

In some examples, the one of the one or more candidate serving cells has either a smallest cell identifier of the one or more candidate serving cells or a largest cell identifier of the one or more candidate serving cells.

In some examples, the priority rule assigns a greater weight to an input when the respective set of reference signals is associated with an active serving cell for the UE than when the respective set of reference signals is associated with a deactivated serving cell for the UE.

In some examples, the priority rule assigns a greater weight to the input when the respective set of reference signals is associated with the deactivated serving cell for the UE than when the respective set of reference signals is associated with only a candidate serving cell for the UE.

In some examples, the priority rule assigns a greater weight to an input when the respective set of reference signals is associated with an intra-frequency measurement type than when the respective set of reference signals is associated with an inter-frequency measurement type.

In some examples, the priority rule assigns a first weight to an input when the respective set of reference signals is associated with an aperiodic report type, a second weight to the input when the respective set of reference signals is associated with an event-triggered report type, a third weight to the input when the respective set of reference signals is associated with a semi-persistent report type, or a fourth weight to the input when the respective set of reference signals is associated with a periodic report type. In some examples, the first weight is greater than the second weight, which is greater than the third weight, which is greater than the fourth weight.

In some examples, parameters of the priority rule include at least one of a type of measurement report, an indication of whether a reference signal received power value or a signal to noise ratio value is included in a corresponding one of the set of multiple CSI reports, a serving cell index, a maximum number of serving cells, a report identifier for a CSI report, a maximum number of CSI report indications, an input distinguishing CSI reports carrying serving cell measurement and candidate cell measurement, a term having a first value indicating that the set of multiple CSI reports is not associated with any reference signal in the serving cell. In some examples, the term has a second value indicating that the set of multiple CSI reports is associated with a reference signal in the serving cell, or a combination thereof.

In some examples, the prioritized CSI report receiving component 1030 is capable of, configured to, or operable to support a means for receiving, from the UE, an indication indicating whether the prioritized CSI report is triggered based on a mobility event at the UE.

In some examples, the indication is received using at least one of an explicit bit in the prioritized CSI report, a field in the prioritized CSI report, one or more scrambling sequences of a demodulation reference signal, or a combination thereof.

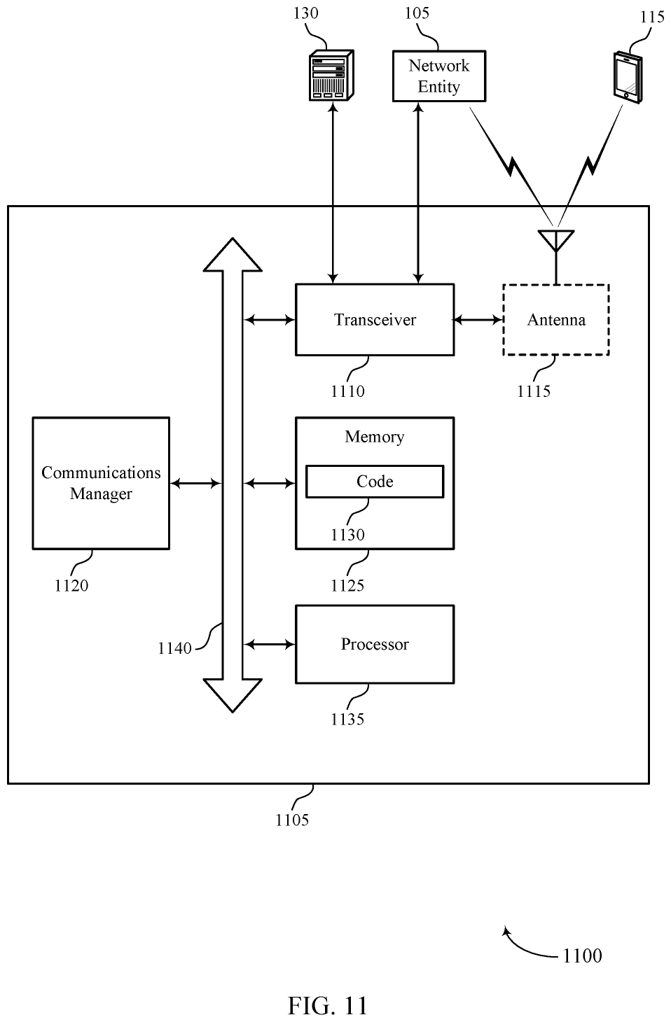

FIG. 11 shows a diagram of a system 1100 including a device 1105 that supports techniques to determine a priority of a CSI report in accordance with one or more aspects of the present disclosure. The device 1105 may be an example of or include the components of a device 805, a device 905, or a network entity 105 as described herein. The device 1105 may communicate with one or more network entities 105, one or more UEs 115, or any combination thereof, which may include communications over one or more wired interfaces, over one or more wireless interfaces, or any combination thereof. The device 1105 may include components that support outputting and obtaining communications, such as a communications manager 1120, a transceiver 1110, an antenna 1115, a memory 1125, code 1130, and a processor 1135. These components may be in electronic communication or otherwise coupled (e.g., operatively, communicatively, functionally, electronically, electrically) via one or more buses (e.g., a bus 1140).

The transceiver 1110 may support bi-directional communications via wired links, wireless links, or both as described herein. In some examples, the transceiver 1110 may include a wired transceiver and may communicate bi-directionally with another wired transceiver. Additionally, or alternatively, in some examples, the transceiver 1110 may include a wireless transceiver and may communicate bi-directionally with another wireless transceiver. In some examples, the device 1105 may include one or more antennas 1115, which may be capable of transmitting or receiving wireless transmissions (e.g., concurrently). The transceiver 1110 may also include a modem to modulate signals, to provide the modulated signals for transmission (e.g., by one or more antennas 1115, by a wired transmitter), to receive modulated signals (e.g., from one or more antennas 1115, from a wired receiver), and to demodulate signals. In some implementations, the transceiver 1110 may include one or more interfaces, such as one or more interfaces coupled with the one or more antennas 1115 that are configured to support various receiving or obtaining operations, or one or more interfaces coupled with the one or more antennas 1115 that are configured to support various transmitting or outputting operations, or a combination thereof. In some implementations, the transceiver 1110 may include or be configured for coupling with one or more processors or memory components that are operable to perform or support operations based on received or obtained information or signals, or to generate information or other signals for transmission or other outputting, or any combination thereof. In some implementations, the transceiver 1110, or the transceiver 1110 and the one or more antennas 1115, or the transceiver 1110 and the one or more antennas 1115 and one or more processors or memory components (for example, the processor 1135, or the memory 1125, or both), may be included in a chip or chip assembly that is installed in the device 1105. In some examples, the transceiver may be operable to support communications via one or more communications links (e.g., a communication link 125, a backhaul communication link 120, a midhaul communication link 162, a fronthaul communication link 168).

The memory 1125 may include RAM and ROM. The memory 1125 may store computer-readable, computer-executable code 1130 including instructions that, when executed by the processor 1135, cause the device 1105 to perform various functions described herein. The code 1130 may be stored in a non-transitory computer-readable medium such as system memory or another type of memory. In some cases, the code 1130 may not be directly executable by the processor 1135 but may cause a computer (e.g., when compiled and executed) to perform functions described herein. In some cases, the memory 1125 may contain, among other things, a BIOS which may control basic hardware or software operation such as the interaction with peripheral components or devices.

The processor 1135 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the processor 1135 may be configured to operate a memory array using a memory controller. In some other cases, a memory controller may be integrated into the processor 1135. The processor 1135 may be configured to execute computer-readable instructions stored in a memory (e.g., the memory 1125) to cause the device 1105 to perform various functions (e.g., functions or tasks supporting techniques to determine a priority of a CSI report). For example, the device 1105 or a component of the device 1105 may include a processor 1135 and memory 1125 coupled with the processor 1135, the processor 1135 and memory 1125 configured to perform various functions described herein. The processor 1135 may be an example of a cloud-computing platform (e.g., one or more physical nodes and supporting software such as operating systems, virtual machines, or container instances) that may host the functions (e.g., by executing code 1130) to perform the functions of the device 1105. The processor 1135 may be any one or more suitable processors capable of executing scripts or instructions of one or more software programs stored in the device 1105 (such as within the memory 1125). In some implementations, the processor 1135 may be a component of a processing system. A processing system may generally refer to a system or series of machines or components that receives inputs and processes the inputs to produce a set of outputs (which may be passed to other systems or components of, for example, the device 1105). For example, a processing system of the device 1105 may refer to a system including the various other components or subcomponents of the device 1105, such as the processor 1135, or the transceiver 1110, or the communications manager 1120, or other components or combinations of components of the device 1105. The processing system of the device 1105 may interface with other components of the device 1105, and may process information received from other components (such as inputs or signals) or output information to other components. For example, a chip or modem of the device 1105 may include a processing system and one or more interfaces to output information, or to obtain information, or both. The one or more interfaces may be implemented as or otherwise include a first interface configured to output information and a second interface configured to obtain information, or a same interface configured to output information and to obtain information, among other implementations. In some implementations, the one or more interfaces may refer to an interface between the processing system of the chip or modem and a transmitter, such that the device 1105 may transmit information output from the chip or modem. Additionally, or alternatively, in some implementations, the one or more interfaces may refer to an interface between the processing system of the chip or modem and a receiver, such that the device 1105 may obtain information or signal inputs, and the information may be passed to the processing system. A person having ordinary skill in the art will readily recognize that a first interface also may obtain information or signal inputs, and a second interface also may output information or signal outputs.

In some examples, a bus 1140 may support communications of (e.g., within) a protocol layer of a protocol stack. In some examples, a bus 1140 may support communications associated with a logical channel of a protocol stack (e.g., between protocol layers of a protocol stack), which may include communications performed within a component of the device 1105, or between different components of the device 1105 that may be co-located or located in different locations (e.g., where the device 1105 may refer to a system in which one or more of the communications manager 1120, the transceiver 1110, the memory 1125, the code 1130, and the processor 1135 may be located in one of the different components or divided between different components).

In some examples, the communications manager 1120 may manage aspects of communications with a core network 130 (e.g., via one or more wired or wireless backhaul links). For example, the communications manager 1120 may manage the transfer of data communications for client devices, such as one or more UEs 115. In some examples, the communications manager 1120 may manage communications with other network entities 105, and may include a controller or scheduler for controlling communications with UEs 115 in cooperation with other network entities 105. In some examples, the communications manager 1120 may support an X2 interface within an LTE/LTE-A wireless communications network technology to provide communication between network entities 105.

The communications manager 1120 may support wireless communications at a network entity in accordance with examples as disclosed herein. For example, the communications manager 1120 is capable of, configured to, or operable to support a means for transmitting, to a UE, control information that schedules the UE to transmit a set of multiple CSI reports during overlapping windows of time, the set of multiple CSI reports each based on measurements of respective sets of reference signals. The communications manager 1120 is capable of, configured to, or operable to support a means for receiving, from the UE and during the overlapping windows of time, a prioritized CSI report from the set of multiple CSI reports in accordance with a priority rule, where the priority rule defines a priority of each of the set of multiple CSI reports, where respective priorities corresponding to the set of multiple CSI reports are based on the respective sets of reference signals being associated with a serving cell for the UE, one or more candidate serving cells for the UE, or both the serving cell for the UE and the one or more candidate serving cells for the UE.

By including or configuring the communications manager 1120 in accordance with examples as described herein, the device 1105 may support techniques for improved communication reliability, reduced latency (e.g., in LTM procedures, in handover procedures), more efficient utilization of communication resources, and improved coordination between devices.

In some examples, the communications manager 1120 may be configured to perform various operations (e.g., receiving, obtaining, monitoring, outputting, transmitting) using or otherwise in cooperation with the transceiver 1110, the one or more antennas 1115 (e.g., where applicable), or any combination thereof. Although the communications manager 1120 is illustrated as a separate component, in some examples, one or more functions described with reference to the communications manager 1120 may be supported by or performed by the transceiver 1110, the processor 1135, the memory 1125, the code 1130, or any combination thereof. For example, the code 1130 may include instructions executable by the processor 1135 to cause the device 1105 to perform various aspects of techniques to determine a priority of a CSI report as described herein, or the processor 1135 and the memory 1125 may be otherwise configured to perform or support such operations.

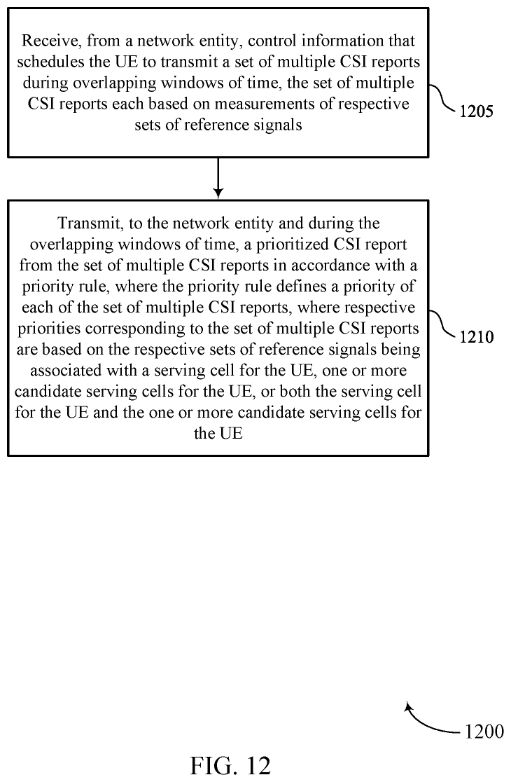

FIG. 12 shows a flowchart illustrating a method 1200 that supports techniques to determine a priority of a CSI report in accordance with aspects of the present disclosure. The operations of the method 1200 may be implemented by a UE or its components as described herein. For example, the operations of the method 1200 may be performed by a UE 115 as described with reference to FIGS. 1 through 7. In some examples, a UE may execute a set of instructions to control the functional elements of the wireless UE to perform the described functions. Additionally, or alternatively, the wireless UE may perform aspects of the described functions using special-purpose hardware.

At 1205, the method may include receiving, from a network entity, control information that schedules the UE to transmit a set of multiple CSI reports during overlapping windows of time, the set of multiple CSI reports each based on measurements of respective sets of reference signals. The operations of 1205 may be performed in accordance with examples as disclosed herein. In some examples, aspects of the operations of 1205 may be performed by a control information component 625 as described with reference to FIG. 6.

At 1210, the method may include transmitting, to the network entity and during the overlapping windows of time, a prioritized CSI report from the set of multiple CSI reports in accordance with a priority rule, where the priority rule defines a priority of each of the set of multiple CSI reports, where respective priorities corresponding to the set of multiple CSI reports are based on the respective sets of reference signals being associated with a serving cell for the UE, one or more candidate serving cells for the UE, or both the serving cell for the UE and the one or more candidate serving cells for the UE. The operations of 1210 may be performed in accordance with examples as disclosed herein. In some examples, aspects of the operations of 1210 may be performed by a CSI report transmitting component 630 as described with reference to FIG. 6.

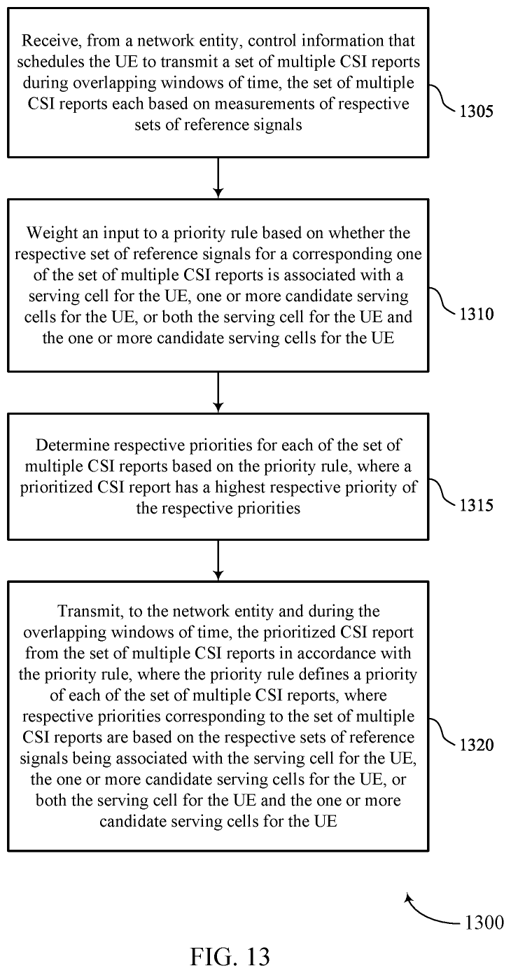

FIG. 13 shows a flowchart illustrating a method 1300 that supports techniques to determine a priority of a CSI report in accordance with aspects of the present disclosure. The operations of the method 1300 may be implemented by a UE or its components as described herein. For example, the operations of the method 1300 may be performed by a UE 115 as described with reference to FIGS. 1 through 7. In some examples, a UE may execute a set of instructions to control the functional elements of the wireless UE to perform the described functions. Additionally, or alternatively, the wireless UE may perform aspects of the described functions using special-purpose hardware.

At 1305, the method may include receiving, from a network entity, control information that schedules the UE to transmit a set of multiple CSI reports during overlapping windows of time, the set of multiple CSI reports each based on measurements of respective sets of reference signals. The operations of 1305 may be performed in accordance with examples as disclosed herein. In some examples, aspects of the operations of 1305 may be performed by a control information component 625 as described with reference to FIG. 6.

At 1310, the method may include weighting an input to the priority rule based on whether the respective set of reference signals for a corresponding one of the set of multiple CSI reports is associated with the serving cell for the UE, the one or more candidate serving cells for the UE, or both the serving cell for the UE and the one or more candidate serving cells for the UE. The operations of 1310 may be performed in accordance with examples as disclosed herein. In some examples, aspects of the operations of 1310 may be performed by a CSI report prioritization component 635 as described with reference to FIG. 6.

At 1315, the method may include determining the respective priorities for each of the set of multiple CSI reports based on the priority rule, where the prioritized CSI report has a highest respective priority of the respective priorities. The operations of 1315 may be performed in accordance with examples as disclosed herein. In some examples, aspects of the operations of 1315 may be performed by a CSI report prioritization component 635 as described with reference to FIG. 6.

At 1320, the method may include transmitting, to the network entity and during the overlapping windows of time, a prioritized CSI report from the set of multiple CSI reports in accordance with a priority rule, where the priority rule defines a priority of each of the set of multiple CSI reports, where respective priorities corresponding to the set of multiple CSI reports are based on the respective sets of reference signals being associated with a serving cell for the UE, one or more candidate serving cells for the UE, or both the serving cell for the UE and the one or more candidate serving cells for the UE. The operations of 1320 may be performed in accordance with examples as disclosed herein. In some examples, aspects of the operations of 1320 may be performed by a CSI report transmitting component 630 as described with reference to FIG. 6.

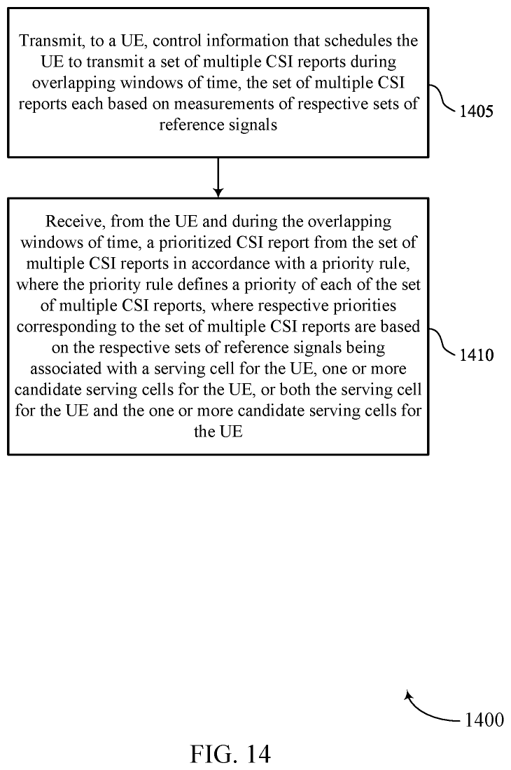

FIG. 14 shows a flowchart illustrating a method 1400 that supports techniques to determine a priority of a CSI report in accordance with aspects of the present disclosure. The operations of the method 1400 may be implemented by a network entity or its components as described herein. For example, the operations of the method 1400 may be performed by a network entity as described with reference to FIGS. 1 through 3 and 8 through 11. In some examples, a network entity may execute a set of instructions to control the functional elements of the wireless network entity to perform the described functions. Additionally, or alternatively, the wireless network entity may perform aspects of the described functions using special-purpose hardware.

At 1405, the method may include transmitting, to a UE, control information that schedules the UE to transmit a set of multiple CSI reports during overlapping windows of time, the set of multiple CSI reports each based on measurements of respective sets of reference signals. The operations of 1405 may be performed in accordance with examples as disclosed herein. In some examples, aspects of the operations of 1405 may be performed by a control information component 1025 as described with reference to FIG. 10.

At 1410, the method may include receiving, from the UE and during the overlapping windows of time, a prioritized CSI report from the set of multiple CSI reports in accordance with a priority rule, where the priority rule defines a priority of each of the set of multiple CSI reports, where respective priorities corresponding to the set of multiple CSI reports are based on the respective sets of reference signals being associated with a serving cell for the UE, one or more candidate serving cells for the UE, or both the serving cell for the UE and the one or more candidate serving cells for the UE. The operations of 1410 may be performed in accordance with examples as disclosed herein. In some examples, aspects of the operations of 1410 may be performed by a prioritized CSI report receiving component 1030 as described with reference to FIG. 10.

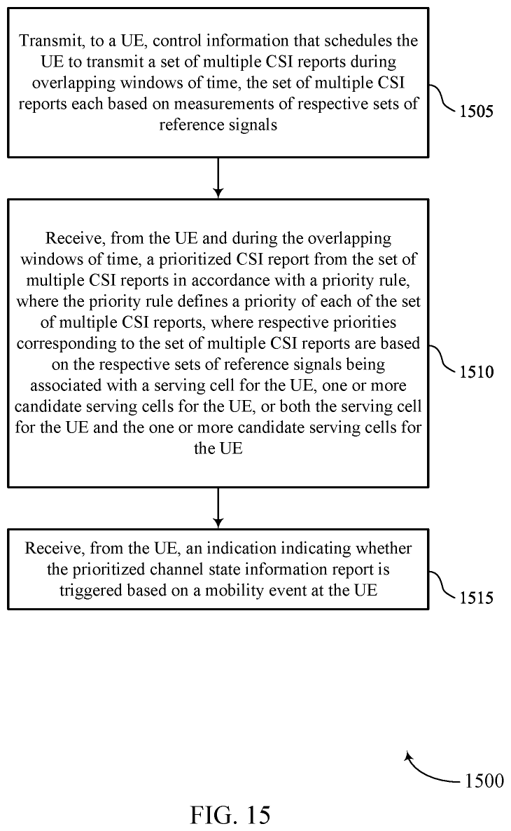

FIG. 15 shows a flowchart illustrating a method 1500 that supports techniques to determine a priority of a CSI report in accordance with aspects of the present disclosure. The operations of the method 1500 may be implemented by a network entity or its components as described herein. For example, the operations of the method 1500 may be performed by a network entity as described with reference to FIGS. 1 through 3 and 8 through 11. In some examples, a network entity may execute a set of instructions to control the functional elements of the wireless network entity to perform the described functions. Additionally, or alternatively, the wireless network entity may perform aspects of the described functions using special-purpose hardware.

At 1505, the method may include transmitting, to a UE, control information that schedules the UE to transmit a set of multiple CSI reports during overlapping windows of time, the set of multiple CSI reports each based on measurements of respective sets of reference signals. The operations of 1505 may be performed in accordance with examples as disclosed herein. In some examples, aspects of the operations of 1505 may be performed by a control information component 1025 as described with reference to FIG. 10.

At 1510, the method may include receiving, from the UE and during the overlapping windows of time, a prioritized CSI report from the set of multiple CSI reports in accordance with a priority rule, where the priority rule defines a priority of each of the set of multiple CSI reports, where respective priorities corresponding to the set of multiple CSI reports are based on the respective sets of reference signals being associated with a serving cell for the UE, one or more candidate serving cells for the UE, or both the serving cell for the UE and the one or more candidate serving cells for the UE. The operations of 1510 may be performed in accordance with examples as disclosed herein. In some examples, aspects of the operations of 1510 may be performed by a prioritized CSI report receiving component 1030 as described with reference to FIG. 10.

At 1515, the method may include receiving, from the UE, an indication indicating whether the prioritized CSI report is triggered based on a mobility event at the UE. The operations of 1515 may be performed in accordance with examples as disclosed herein. In some examples, aspects of the operations of 1515 may be performed by a prioritized CSI report receiving component 1030 as described with reference to FIG. 10.

The following provides an overview of aspects of the present disclosure:

Aspect 1: A method for wireless communications at a UE, comprising: receiving, from a network entity, control information that schedules the UE to transmit a plurality of channel state information reports during overlapping windows of time, the plurality of channel state information reports each based on measurements of respective sets of reference signals; and transmitting, to the network entity and during the overlapping windows of time, a prioritized channel state information report from the plurality of channel state information reports in accordance with a priority rule, wherein the priority rule defines a priority of each of the plurality of channel state information reports, wherein respective priorities corresponding to the plurality of channel state information reports are based at least in part on the respective sets of reference signals being associated with a serving cell for the UE, one or more candidate serving cells for the UE, or both the serving cell for the UE and the one or more candidate serving cells for the UE.

Aspect 2: The method of aspect 1, further comprising: determining the respective priorities for each of the plurality of channel state information reports based at least in part on the priority rule, wherein the prioritized channel state information report has a highest respective priority of the respective priorities.

Aspect 3: The method of any of aspects 1 through 2, further comprising: weighting an input to the priority rule based on whether the respective set of reference signals for a corresponding one of the plurality of channel state information reports is associated with the serving cell for the UE, the one or more candidate serving cells for the UE, or both the serving cell for the UE and the one or more candidate serving cells for the UE.

Aspect 4: The method of aspect 3, wherein the input is assigned a greater weight when the respective set of reference signals is associated with the serving cell for the UE than when the respective set of reference signals is associated with only the one or more candidate serving cells for the UE.

Aspect 5: The method of any of aspects 1 through 4, wherein the priority rule includes, as an input, a cell identifier associated with a respective one of the plurality of channel state information reports, the cell identifier is of the serving cell when the respective sets of reference signals are associated with the serving cell for the UE or associated with both the serving cell for the UE and the one or more candidate serving cells for the UE.

Aspect 6: The method of any of aspects 1 through 5, wherein the priority rule includes, as an input, a cell identifier associated with a respective one of the plurality of channel state information reports, the cell identifier is of a one of the one or more candidate serving cells when the respective sets of reference signals are associated with only the one or more candidate serving cells for the UE.

Aspect 7: The method of aspect 6, wherein the one of the one or more candidate serving cells has either a smallest cell identifier of the one or more candidate serving cells or a largest cell identifier of the one or more candidate serving cells.

Aspect 8: The method of any of aspects 1 through 7, further comprising: determining the prioritized channel state information report based at least in part on the priority rule, wherein the priority rule assigns a greater weight to an input when the respective set of reference signals is associated with an active serving cell for the UE than when the respective set of reference signals is associated with a deactivated serving cell for the UE.

Aspect 9: The method of aspect 8, wherein the priority rule assigns a greater weight to the input when the respective set of reference signals is associated with the deactivated serving cell for the UE than when the respective set of reference signals is associated with only a candidate serving cell for the UE.

Aspect 10: The method of any of aspects 1 through 9, further comprising: determining the prioritized channel state information report based at least in part on the priority rule, wherein the priority rule assigns a greater weight to an input when the respective set of reference signals is associated with an intra-frequency measurement type than when the respective set of reference signals is associated with an inter-frequency measurement type.

Aspect 11: The method of any of aspects 1 through 10, further comprising: determining the prioritized channel state information report based at least in part on the priority rule, wherein the priority rule assigns a first weight to an input when the respective set of reference signals is associated with an aperiodic report type, a second weight to the input when the respective set of reference signals is associated with an event-triggered report type, a third weight to the input when the respective set of reference signals is associated with a semi-persistent report type, or a fourth weight to the input when the respective set of reference signals is associated with a periodic report type, wherein the first weight is greater than the second weight, which is greater than the third weight, which is greater than the fourth weight.

Aspect 12: The method of any of aspects 1 through 11, further comprising: determining a first channel state information report corresponding to a first set of reference signals, wherein the first set of reference signals is associated with the serving cell for the UE; and determining a second channel state information report corresponding to a second set of reference signals, wherein the second set of reference signals is associated with a candidate serving cell for the UE, and wherein transmitting the prioritized channel state information report comprises transmitting the first channel state information report in accordance with the priority rule prioritizing the serving cell for the UE over the candidate serving cell for the UE.

Aspect 13: The method of any of aspects 1 through 12, wherein parameters of the priority rule comprise at least one of a type of measurement report, an indication of whether a reference signal received power value or a signal to noise ratio value is included in a corresponding one of the plurality of channel state information reports, a serving cell index, a maximum number of serving cells, a report identifier for a channel state information report, a maximum number of channel state information report indications, an input distinguishing channel state information reports carrying serving cell measurement and candidate cell measurement, a term having a first value indicating that the plurality of channel state information reports is not associated with any reference signal in the serving cell, the term has a second value indicating that the plurality of channel state information reports is associated with a reference signal in the serving cell, or a combination thereof.

Aspect 14: The method of any of aspects 1 through 13, further comprising: transmitting, to the network entity, an indication indicating whether the prioritized channel state information report is triggered based at least in part on a mobility event at the UE.

Aspect 15: The method of aspect 14, wherein the indication is transmitted using at least one of an explicit bit in the prioritized channel state information report, a field in the prioritized channel state information report, one or more scrambling sequences of a demodulation reference signal, or a combination thereof.

Aspect 16: A method for wireless communications at a network entity, comprising: transmitting, to a UE, control information that schedules the UE to transmit a plurality of channel state information reports during overlapping windows of time, the plurality of channel state information reports each based on measurements of respective sets of reference signals; and receiving, from the UE and during the overlapping windows of time, a prioritized channel state information report from the plurality of channel state information reports in accordance with a priority rule, wherein the priority rule defines a priority of each of the plurality of channel state information reports, wherein respective priorities corresponding to the plurality of channel state information reports are based at least in part on the respective sets of reference signals being associated with a serving cell for the UE, one or more candidate serving cells for the UE, or both the serving cell for the UE and the one or more candidate serving cells for the UE.

Aspect 17: The method of aspect 16, wherein the priority rule indicates that the prioritized channel state information report has a highest respective priority of the respective priorities.

Aspect 18: The method of any of aspects 16 through 17, wherein the priority rule indicates that an input to the priority rule is weighed based on whether the respective set of reference signals for a corresponding one of the plurality of channel state information reports is associated with the serving cell for the UE, the one or more candidate serving cells for the UE, or both the serving cell for the UE and the one or more candidate serving cells for the UE.

Aspect 19: The method of aspect 18, wherein the input is assigned a greater weight when the respective set of reference signals is associated with the serving cell for the UE than when the respective set of reference signals is associated with only the one or more candidate serving cells for the UE.

Aspect 20: The method of any of aspects 16 through 19, wherein the priority rule includes, as an input, a cell identifier associated with a respective one of the plurality of channel state information reports, the cell identifier is of the serving cell when the respective sets of reference signals are associated with the serving cell for the UE or associated with both the serving cell for the UE and the one or more candidate serving cells for the UE.

Aspect 21: The method of any of aspects 16 through 20, wherein the priority rule includes, as an input, a cell identifier associated with a respective one of the plurality of channel state information reports, the cell identifier is of a one of the one or more candidate serving cells when the respective sets of reference signals are associated with only the one or more candidate serving cells for the UE.

Aspect 22: The method of aspect 21, wherein the one of the one or more candidate serving cells has either a smallest cell identifier of the one or more candidate serving cells or a largest cell identifier of the one or more candidate serving cells.

Aspect 23: The method of any of aspects 16 through 22, wherein the priority rule assigns a greater weight to an input when the respective set of reference signals is associated with an active serving cell for the UE than when the respective set of reference signals is associated with a deactivated serving cell for the UE.

Aspect 24: The method of aspect 23, wherein the priority rule assigns a greater weight to the input when the respective set of reference signals is associated with the deactivated serving cell for the UE than when the respective set of reference signals is associated with only a candidate serving cell for the UE.

Aspect 25: The method of any of aspects 16 through 24, wherein the priority rule assigns a greater weight to an input when the respective set of reference signals is associated with an intra-frequency measurement type than when the respective set of reference signals is associated with an inter-frequency measurement type.

Aspect 26: The method of any of aspects 16 through 25, wherein the priority rule assigns a first weight to an input when the respective set of reference signals is associated with an aperiodic report type, a second weight to the input when the respective set of reference signals is associated with an event-triggered report type, a third weight to the input when the respective set of reference signals is associated with a semi-persistent report type, or a fourth weight to the input when the respective set of reference signals is associated with a periodic report type, the first weight is greater than the second weight, which is greater than the third weight, which is greater than the fourth weight.

Aspect 27: The method of any of aspects 16 through 26, wherein parameters of the priority rule comprise at least one of a type of measurement report, an indication of whether a reference signal received power value or a signal to noise ratio value is included in a corresponding one of the plurality of channel state information reports, a serving cell index, a maximum number of serving cells, a report identifier for a channel state information report, a maximum number of channel state information report indications, an input distinguishing channel state information reports carrying serving cell measurement and candidate cell measurement, a term having a first value indicating that the plurality of channel state information reports is not associated with any reference signal in the serving cell, the term has a second value indicating that the plurality of channel state information reports is associated with a reference signal in the serving cell, or a combination thereof.

Aspect 28: The method of any of aspects 16 through 27, further comprising: receiving, from the UE, an indication indicating whether the prioritized channel state information report is triggered based at least in part on a mobility event at the UE.

Aspect 29: The method of aspect 28, wherein the indication is received using at least one of an explicit bit in the prioritized channel state information report, a field in the prioritized channel state information report, one or more scrambling sequences of a demodulation reference signal, or a combination thereof.

Aspect 30: An apparatus for wireless communications at a UE, comprising a processor; memory coupled with the processor; and instructions stored in the memory and executable by the processor to cause the apparatus to perform a method of any of aspects 1 through 15.

Aspect 31: An apparatus for wireless communications at a UE, comprising at least one means for performing a method of any of aspects 1 through 15.

Aspect 32: A non-transitory computer-readable medium storing code for wireless communications at a UE, the code comprising instructions executable by a processor to perform a method of any of aspects 1 through 15.

Aspect 33: An apparatus for wireless communications at a network entity, comprising a processor; memory coupled with the processor; and instructions stored in the memory and executable by the processor to cause the apparatus to perform a method of any of aspects 16 through 29.

Aspect 34: An apparatus for wireless communications at a network entity, comprising at least one means for performing a method of any of aspects 16 through 29.

Aspect 35: A non-transitory computer-readable medium storing code for wireless communications at a network entity, the code comprising instructions executable by a processor to perform a method of any of aspects 16 through 29.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. An apparatus for wireless communications at a user equipment (UE), comprising:
a processor;
memory coupled with the processor; and
instructions stored in the memory and executable by the processor to cause the apparatus to:
receive, from a network entity, control information that schedules the UE to transmit a plurality of channel state information reports during overlapping windows of time, the plurality of channel state information reports each based on measurements of respective sets of reference signals; and
transmit, to the network entity and during the overlapping windows of time, a prioritized channel state information report from the plurality of channel state information reports in accordance with a priority rule, wherein the priority rule defines a priority of each of the plurality of channel state information reports, wherein respective priorities corresponding to the plurality of channel state information reports are based at least in part on the respective sets of reference signals being associated with a serving cell for the UE, one or more candidate serving cells for the UE, or both the serving cell for the UE and the one or more candidate serving cells for the UE.

2. The apparatus of claim 1, wherein the instructions are further executable by the processor to cause the apparatus to:
determine the respective priorities for each of the plurality of channel state information reports based at least in part on the priority rule, wherein the prioritized channel state information report has a highest respective priority of the respective priorities.

3. The apparatus of claim 1, wherein the instructions are further executable by the processor to cause the apparatus to:
weight an input to the priority rule based on whether the respective set of reference signals for a corresponding one of the plurality of channel state information reports is associated with the serving cell for the UE, the one or more candidate serving cells for the UE, or both the serving cell for the UE and the one or more candidate serving cells for the UE.

4. The apparatus of claim 3, wherein the input is assigned a greater weight when the respective set of reference signals is associated with the serving cell for the UE than when the respective set of reference signals is associated with only the one or more candidate serving cells for the UE.

5. The apparatus of claim 1, wherein the priority rule includes, as an input, a cell identifier associated with a respective one of the plurality of channel state information reports, wherein the cell identifier is of the serving cell when the respective sets of reference signals are associated with the serving cell for the UE or associated with both the serving cell for the UE and the one or more candidate serving cells for the UE.

6. The apparatus of claim 1, wherein the priority rule includes, as an input, a cell identifier associated with a respective one of the plurality of channel state information reports, wherein the cell identifier is of a one of the one or more candidate serving cells when the respective sets of reference signals are associated with only the one or more candidate serving cells for the UE.

7. The apparatus of claim 6, wherein the one of the one or more candidate serving cells has either a smallest cell identifier of the one or more candidate serving cells or a largest cell identifier of the one or more candidate serving cells.

8. The apparatus of claim 1, wherein the instructions are further executable by the processor to cause the apparatus to:
determine the prioritized channel state information report based at least in part on the priority rule, wherein the priority rule assigns a greater weight to an input when the respective set of reference signals is associated with an active serving cell for the UE than when the respective set of reference signals is associated with a deactivated serving cell for the UE.

9. The apparatus of claim 8, wherein the priority rule assigns a greater weight to the input when the respective set of reference signals is associated with the deactivated serving cell for the UE than when the respective set of reference signals is associated with only a candidate serving cell for the UE.

10. The apparatus of claim 1, wherein the instructions are further executable by the processor to cause the apparatus to:
determine the prioritized channel state information report based at least in part on the priority rule, wherein the priority rule assigns a greater weight to an input when the respective set of reference signals is associated with an intra-frequency measurement type than when the respective set of reference signals is associated with an inter-frequency measurement type.

11. The apparatus of claim 1, wherein the instructions are further executable by the processor to cause the apparatus to:
determine the prioritized channel state information report based at least in part on the priority rule, wherein the priority rule assigns a first weight to an input when the respective set of reference signals is associated with an aperiodic report type, a second weight to the input when the respective set of reference signals is associated with an event-triggered report type, a third weight to the input when the respective set of reference signals is associated with a semi-persistent report type, or a fourth weight to the input when the respective set of reference signals is associated with a periodic report type, wherein the first weight is greater than the second weight, which is greater than the third weight, which is greater than the fourth weight.

12. The apparatus of claim 1, wherein the instructions are further executable by the processor to cause the apparatus to:
determine a first channel state information report corresponding to a first set of reference signals, wherein the first set of reference signals is associated with the serving cell for the UE; and
determine a second channel state information report corresponding to a second set of reference signals, wherein the second set of reference signals is associated with a candidate serving cell for the UE, and wherein transmitting the prioritized channel state information report comprises transmitting the first channel state information report in accordance with the priority rule prioritizing the serving cell for the UE over the candidate serving cell for the UE.

13. The apparatus of claim 1, wherein parameters of the priority rule comprise at least one of a type of measurement report, an indication of whether a reference signal received power value or a signal to noise ratio value is included in a corresponding one of the plurality of channel state information reports, a serving cell index, a maximum number of serving cells, a report identifier for a channel state information report, a maximum number of channel state information report indications, an input distinguishing channel state information reports carrying serving cell measurement and candidate cell measurement, a term having a first value indicating that the plurality of channel state information reports is not associated with any reference signal in the serving cell, wherein the term has a second value indicating that the plurality of channel state information reports is associated with a reference signal in the serving cell, or a combination thereof.

14. The apparatus of claim 1, wherein the instructions are further executable by the processor to cause the apparatus to:
transmit, to the network entity, an indication indicating whether the prioritized channel state information report is triggered based at least in part on a mobility event at the UE.

15. The apparatus of claim 14, wherein the indication is transmitted using at least one of an explicit bit in the prioritized channel state information report, a field in the prioritized channel state information report, one or more scrambling sequences of a demodulation reference signal, or a combination thereof.

16. An apparatus for wireless communications at a network entity, comprising:
a processor;
memory coupled with the processor; and
instructions stored in the memory and executable by the processor to cause the apparatus to:
transmit, to a user equipment (UE), control information that schedules the UE to transmit a plurality of channel state information reports during overlapping windows of time, the plurality of channel state information reports each based on measurements of respective sets of reference signals; and
receive, from the UE and during the overlapping windows of time, a prioritized channel state information report from the plurality of channel state information reports in accordance with a priority rule, wherein the priority rule defines a priority of each of the plurality of channel state information reports, wherein respective priorities corresponding to the plurality of channel state information reports are based at least in part on the respective sets of reference signals being associated with a serving cell for the UE, one or more candidate serving cells for the UE, or both the serving cell for the UE and the one or more candidate serving cells for the UE.

17. The apparatus of claim 16, wherein the priority rule indicates that the prioritized channel state information report has a highest respective priority of the respective priorities.

18. The apparatus of claim 16, wherein the priority rule indicates that an input to the priority rule is weighed based on whether the respective set of reference signals for a corresponding one of the plurality of channel state information reports is associated with the serving cell for the UE, the one or more candidate serving cells for the UE, or both the serving cell for the UE and the one or more candidate serving cells for the UE.

19. The apparatus of claim 18, wherein the input is assigned a greater weight when the respective set of reference signals is associated with the serving cell for the UE than when the respective set of reference signals is associated with only the one or more candidate serving cells for the UE.

20. The apparatus of claim 16, wherein the priority rule includes, as an input, a cell identifier associated with a respective one of the plurality of channel state information reports, wherein the cell identifier is of the serving cell when the respective sets of reference signals are associated with the serving cell for the UE or associated with both the serving cell for the UE and the one or more candidate serving cells for the UE.

21. The apparatus of claim 16, wherein the priority rule includes, as an input, a cell identifier associated with a respective one of the plurality of channel state information reports, wherein the cell identifier is of a one of the one or more candidate serving cells when the respective sets of reference signals are associated with only the one or more candidate serving cells for the UE.

22. The apparatus of claim 21, wherein the one of the one or more candidate serving cells has either a smallest cell identifier of the one or more candidate serving cells or a largest cell identifier of the one or more candidate serving cells.

23. The apparatus of claim 16, wherein the priority rule assigns a greater weight to an input when the respective set of reference signals is associated with an active serving cell for the UE than when the respective set of reference signals is associated with a deactivated serving cell for the UE.

24. The apparatus of claim 23, wherein the priority rule assigns a greater weight to the input when the respective set of reference signals is associated with the deactivated serving cell for the UE than when the respective set of reference signals is associated with only a candidate serving cell for the UE.

25. The apparatus of claim 16, wherein the priority rule assigns a greater weight to an input when the respective set of reference signals is associated with an intra-frequency measurement type than when the respective set of reference signals is associated with an inter-frequency measurement type.

26. The apparatus of claim 16, wherein the priority rule assigns a first weight to an input when the respective set of reference signals is associated with an aperiodic report type, a second weight to the input when the respective set of reference signals is associated with an event-triggered report type, a third weight to the input when the respective set of reference signals is associated with a semi-persistent report type, or a fourth weight to the input when the respective set of reference signals is associated with a periodic report type, wherein the first weight is greater than the second weight, which is greater than the third weight, which is greater than the fourth weight.

27. The apparatus of claim 16, wherein parameters of the priority rule comprise at least one of a type of measurement report, an indication of whether a reference signal received power value or a signal to noise ratio value is included in a corresponding one of the plurality of channel state information reports, a serving cell index, a maximum number of serving cells, a report identifier for a channel state information report, a maximum number of channel state information report indications, an input distinguishing channel state information reports carrying serving cell measurement and candidate cell measurement, a term having a first value indicating that the plurality of channel state information reports is not associated with any reference signal in the serving cell, wherein the term has a second value indicating that the plurality of channel state information reports is associated with a reference signal in the serving cell, or a combination thereof.

28. The apparatus of claim 16, wherein the instructions are further executable by the processor to cause the apparatus to:
receive, from the UE, an indication indicating whether the prioritized channel state information report is triggered based at least in part on a mobility event at the UE.

29. A method for wireless communications at a user equipment (UE), comprising:
receiving, from a network entity, control information that schedules the UE to transmit a plurality of channel state information reports during overlapping windows of time, the plurality of channel state information reports each based on measurements of respective sets of reference signals; and
transmitting, to the network entity and during the overlapping windows of time, a prioritized channel state information report from the plurality of channel state information reports in accordance with a priority rule, wherein the priority rule defines a priority of each of the plurality of channel state information reports, wherein respective priorities corresponding to the plurality of channel state information reports are based at least in part on the respective sets of reference signals being associated with a serving cell for the UE, one or more candidate serving cells for the UE, or both the serving cell for the UE and the one or more candidate serving cells for the UE.

30. A method for wireless communications at a network entity, comprising:
transmitting, to a user equipment (UE), control information that schedules the UE to transmit a plurality of channel state information reports during overlapping windows of time, the plurality of channel state information reports each based on measurements of respective sets of reference signals; and
receiving, from the UE and during the overlapping windows of time, a prioritized channel state information report from the plurality of channel state information reports in accordance with a priority rule, wherein the priority rule defines a priority of each of the plurality of channel state information reports, wherein respective priorities corresponding to the plurality of channel state information reports are based at least in part on the respective sets of reference signals being associated with a serving cell for the UE, one or more candidate serving cells for the UE, or both the serving cell for the UE and the one or more candidate serving cells for the UE.
